(19) United States
(12) Patent Application Publication
(10) Pub. No.: US 2026/0122588 A1
(43) Pub. Date: Apr. 30, 2026

(54) Coordinated Data Frame Exchange Sequence

(71) Applicant: Apple Inc., Cupertino, CA (US)

(72) Inventors: Yanjun Sun, San Diego, CA (US); Wook Bong Lee, San Jose, CA (US); Tianyu Wu, Monterey, CA (US); Yong Ho Seok, Cupertino, CA (US); Yoel Boger, Shoham (IL); Ahmad Reza Hedayat, Carlsbad, CA (US); Morteza Mehrnoush, Hayward, CA (US); Min Young Park, San Ramon, CA (US)

(21) Appl. No.: 19/363,526

(22) Filed: Oct. 20, 2025

Related U.S. Application Data
(60) Provisional application No. 63/714,001, filed on Oct. 30, 2024.
(60) Provisional application No. 63/714,038, filed on Oct. 30, 2024.
(60) Provisional application No. 63/744,010, filed on Jan. 10, 2025.

(51) Int. Cl. H04W 56/00; H04B 7/024

(52) U.S. Cl. CPC H04W 56/001; H04B 7/024

(57) ABSTRACT

This disclosure relates to methods for performing coordinated frame exchange in a wireless local area network. A first access point wireless device and a second access point wireless device can perform announce and response frame exchange for a coordinated data frame exchange. Initial control frame and initial control response exchanges can be performed between the access point wireless devices and associated non-access point wireless devices. A coordinated data frame can be transmitted. One or more block acknowledgement frames can be received in response to the coordinated data frame.

### PRIORITY INFORMATION

This application claims priority to U.S. provisional patent application Ser. No. 63/714,001, entitled “Coordinated Beamforming Sounding Exchange Framework,” filed Oct. 30, 2024, U.S. provisional patent application Ser. No. 63/714,038, entitled “Coordinated Beamforming Data Frame Exchange Framework,” filed Oct. 30, 2024, and U.S. provisional patent application Ser. No. 63/744,010, entitled “Coordinated Data Frame Exchange Sequence,” filed Jan. 10, 2025, which are hereby incorporated by reference in their entirety as though fully and completely set forth herein.

### TECHNICAL FIELD

The present application relates to wireless communication, including techniques and devices for efficient coordinated beamforming and spatial reuse in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. As such wireless networks can become increasingly densely deployed, the potential for interference from nearby networks to impact the efficiency of such communications can also increase. Accordingly, improvements in the field are desired.

### SUMMARY

Embodiments are presented herein of, inter alia, systems, apparatuses, and methods for devices to efficiently perform coordinated beamforming (CBF) sounding and data operations and coordinated spatial reuse operations in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

Various techniques are described herein for use during the CBF sounding phase, according to some embodiments. These can include techniques for providing network allocation vector (NAV) protection, as well as for reporting and recovering from sounding failure. Techniques for providing options for a STA to opt-out of CBF, as well as preamble settings for sounding null data packets (NDP) and beamforming reports (BFR) to account for the inclusion of multiple access points and associated stations with differing basic service set identification information during CBF sounding, are also described herein.

Techniques are also described herein for use during the CBF data phase, according to some embodiments. These can include multiple possible CBF data frame exchange sequences, which can include use of staggered initial control frame and initial control response structure or a multi-user initial control frame and initial control response structure. Various technical details for such CBF data frame exchange sequences are described herein, including for handling enhanced multi-link single radio state machine operation, NAV settings, failure recovery, acknowledgement procedures, and security, among others. Possible CBF physical layer protocol data unit alignment techniques are also described herein.

Note further that at least some of the techniques described herein can also or alternatively apply for other multi-AP schemes, such as coordinated spatial reuse, joint transmissions, etc.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for performing coordinated beamforming (CBF) sounding in a wireless local area network, according to some embodiments;

FIG. 6 is a flowchart diagram illustrating an example method for performing CBF data frame exchange in a wireless local area network, according to some embodiments;

FIG. 7 illustrates example aspects of a possible system in which CBF can be performed, according to some embodiments;

FIG. 8 illustrates an example timeline in which CBF sounding and subsequent CBF data frame transmission can occur, according to some embodiments;

FIG. 9 illustrates aspects of two example timelines for handling sounding timing for CBF, according to some embodiments;

FIG. 10 illustrates aspects of a scenario in which hidden node interference can impact CBF sounding operation, according to some embodiments;

FIGS. 11-12 illustrate example aspects of possible joint approaches for CBF sounding operation, according to some embodiments;

FIG. 13 illustrates example aspects of a possible sequential approach for CBF sounding operation, according to some embodiments;

FIG. 14 illustrates example aspects of various possible failure handling approaches for CBF sounding, according to some embodiments;

FIG. 15 is a timing diagram illustrating example aspects of one possible frame exchange sequence for CBF data frame exchange, according to some embodiments;

FIG. 16 is a timing diagram illustrating example aspects of another possible frame exchange sequence for CBF data frame exchange, according to some embodiments;

FIG. 17 is a timing diagram illustrating example aspects of still another possible frame exchange sequence for CBF data frame exchange, according to some embodiments;

FIG. 18 is a timing diagram illustrating example aspects of yet another possible frame exchange sequence for CBF data frame exchange, according to some embodiments;

FIGS. 19-21 are timing diagrams illustrating example aspects of possible frame exchange sequences for coordinated spatial reuse (C-SR) data frame exchange, according to some embodiments;

FIGS. 22-23 illustrate example aspects of possible network allocation vector handling approaches for a CBF data frame exchange sequence, according to some embodiments;

FIG. 24 illustrates example aspects of possible block acknowledgement scheduling approaches for a CBF data frame exchange sequence, according to some embodiments;

FIG. 25 illustrates example aspects of a possible CBF data frame exchange sequence including aligned physical layer preambles for CBF data frames, according to some embodiments;

FIG. 26 illustrates example aspects of a possible scenario in which one or more special wireless device identifiers can be defined and assigned for CBF data frame exchanges, according to some embodiments;

FIG. 27 illustrates example aspects of a possible scenario in which resource unit allocation in physical layer signaling is expanded to be based on basic service set color and station identifier for CBF data frame exchanges, according to some embodiments;

FIG. 28 illustrates example aspects of a possible scenario in which a first content channel can carry resource unit allocation for one basic service set and a second content channel can carry resource unit allocation for another basic service set in physical layer signaling for CBF data frame exchanges, according to some embodiments;

FIG. 29 illustrates further details of a possible physical layer signaling format that can be used for one or more of the approaches of FIGS. 27-28, according to some embodiments;

FIGS. 30-31 illustrate example aspects of a possible physical layer signaling format approach for U-SIG1 and UHR-SIG common fields for non-orthogonal frequency division multiple access CBF transmission, according to some embodiments;

FIG. 32 illustrates aspects of a possible CBF physical layer signaling format approach in which basic service set color can be signaled for both access points, according to some embodiments;

FIG. 33 illustrates aspects of a possible physical layer signaling format approach that can be used to differentiate user fields for different access points, for example for use in conjunction with the example approach of FIG. 27, according to some embodiments;

FIG. 34 illustrates example aspects of a possible scenario in which partial bandwidth CBF data frame transmission can be performed, according to some embodiments;

FIG. 35 illustrates a possible UHR-SIG user field for orthogonal frequency division multiple-access transmission for partial bandwidth CBF operation, according to some embodiments;

FIG. 36 illustrates aspects of a possible U-SIG format in which physical layer protocol data unit type field can indicate a full bandwidth CBF physical layer protocol data unit or a partial bandwidth CBF physical layer protocol data unit, according to some embodiments; and

FIG. 37 illustrates aspects of a possible UHR SIG common field format in which a partial bandwidth CBF field can be used to indicate a partial bandwidth CBF physical layer protocol data unit, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point”(or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

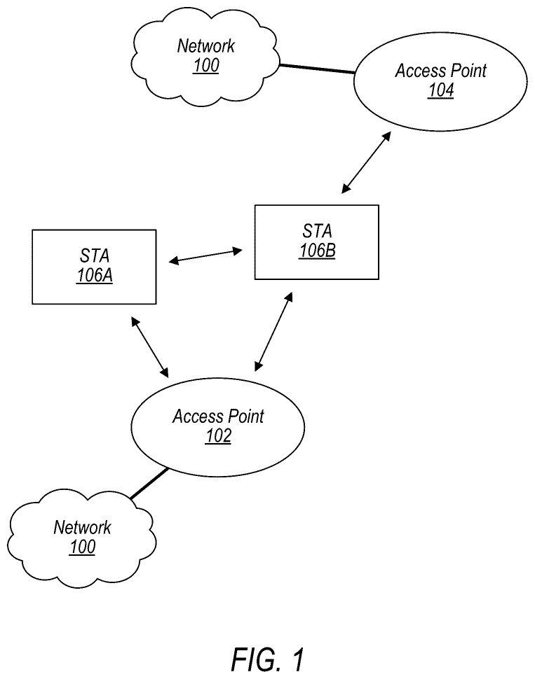

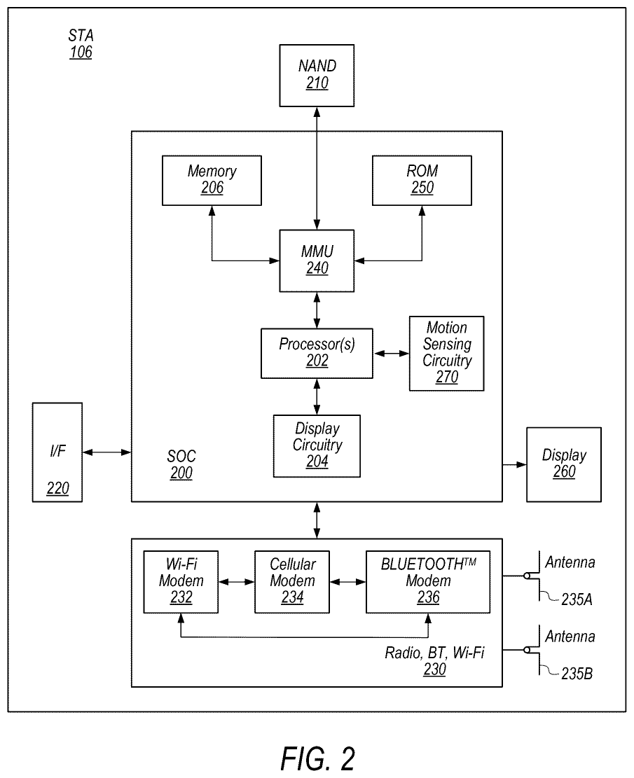

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for efficient coordinated beamforming sounding and data operations in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for efficient coordinated beamforming sounding and data operations described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

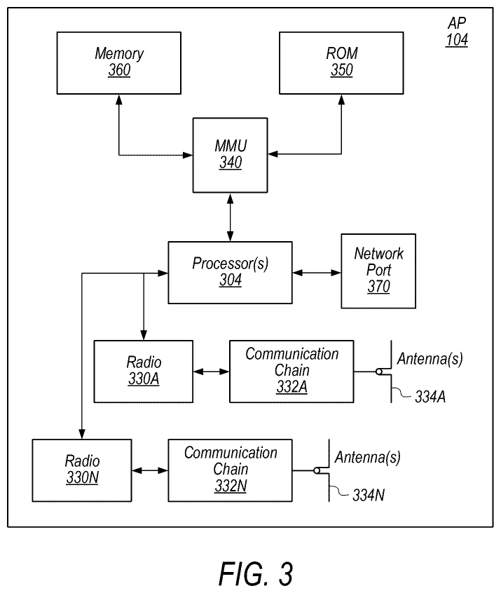

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as techniques for performing efficient coordinated beamforming sounding and data operations, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

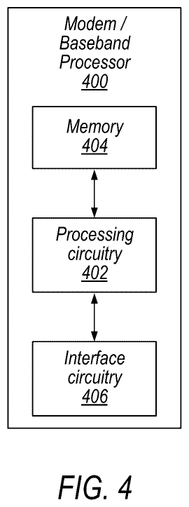

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio / transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as techniques for efficient coordinated beamforming sounding and data operations, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

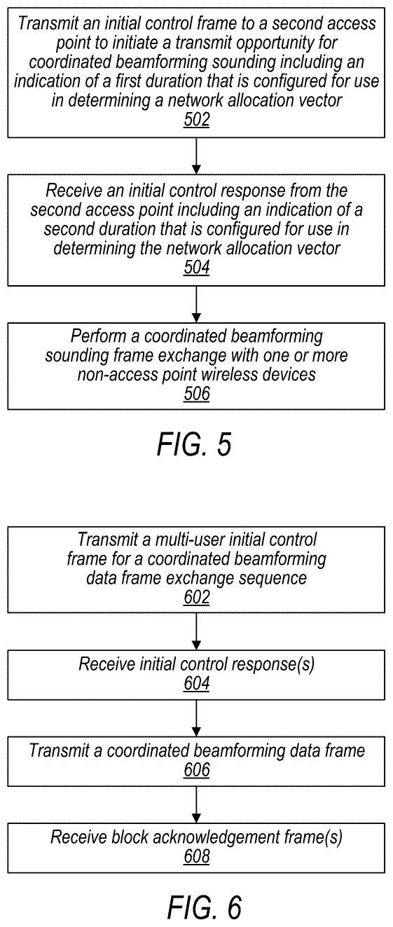

### FIGS. 5-6—Coordinated Beamforming Sounding and Data Phase Flowcharts

An access point (AP) wireless device can provide one or more basic service sets (BSSs). In some embodiments, the AP wireless device can be an AP multi-link device (MLD), which can be capable of providing a BSS on each of multiple links, such as on a 2.4 GHz link, a 5 GHz link, and/or a 6 GHz link. The AP wireless device can operate in a standalone manner or can be affiliated with one or more other devices, e.g., as part of a larger network. For example, the AP wireless device could be a member of a multi-access point (MAP) system, which could include multiple AP wireless devices, in some embodiments.

The AP wireless device can establish a wireless association with one or more non-AP (or “STA”) wireless devices. Such wireless associations can be established using Wi-Fi, wireless communication techniques that are based at least in part on Wi-Fi, and/or any of various other wireless communication technologies, according to various embodiments. For example, an access point (AP) wireless device can provide (e.g., broadcast) beacon transmissions including information for associating with the AP wireless device, and one or more other wireless devices (e.g., non-AP wireless devices) can request to associate with the AP wireless device using the information provided in the beacon transmissions, as one possibility. Use of (e.g., unicast) probe requests and probe responses can also be possible, in some instances, for a non-AP wireless device to obtain AP parameters and/or other system information for the AP wireless device. Variations and/or other techniques for establishing an association are also possible.

The AP wireless device can provide wireless local area network functionality to associated wireless devices, at least according to some embodiments. As part of the wireless local area network functionality, it can be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

For example, at least according to some embodiments, performing a downlink data transmission from the AP wireless device to a non-AP wireless device in such a wireless local area network can include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame can include physical layer signaling (e.g., including a preamble for frame detection, timing and frequency synchronization, channel estimation, etc., and header information indicating packet configuration, format, data rates, channel occupation time, and/or other control information) and data (which can in turn include one or more higher layer packets, such as media access control (MAC) protocol data units (MPDUs). Note that other types of transmissions (e.g., including triggered uplink frames, enhanced distributed channel access (EDCA) uplink frames, transmission opportunity (TXOP) sharing for peer-to-peer (P2P) communications, etc.) can also be possible in such a wireless local area network.

In some embodiments, coordinated beamforming (CBF) operation can be possible in a WLAN setting. Such operation can include multiple access point wireless devices preparing for and performing coordinated beamforming and nulling transmissions to associated non-access point wireless devices to potentially improve efficiency and overall network capacity. To prepare for the coordinated beamforming and nulling transmissions, a sounding phase can be performed between the various devices involved, e.g., to enable the access point devices to effectively form the beamed and nulled signals for data transmissions.

FIG. 5 is a flowchart diagram illustrating a method for supporting such coordinated beamforming sounding operation in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

A first access point wireless device can transmit, to a second access point wireless device, an initial control frame (ICF) to initiate a transmit opportunity (TXOP) for coordinated beamforming (CBF) sounding (502). The ICF can indicate a (“first”) duration value that is configured for use in determining a network allocation vector (NAV), e.g., by recipient devices, potentially including the second access point wireless device, non-access point wireless devices associated with the first access point wireless device, overlapping basic service set wireless devices, etc. The first duration can be configured to protect an entire CBF sounding sequence, or possibly multiple CBF sounding sequences in the TXOP. As another possibility, the first duration can be configured to protect a more limited portion of the CBF sounding sequence, such as until the start of transmission of a beamforming report poll frame. This approach can avoid blocking medium use for scenarios in which NAV protection for the entire sequence is not needed, such as if BFR information can be provided from the first access point wireless device to the second access point wireless device via a backhaul link.

An access point wireless device that initiates a TXOP in such a way can be referred to herein as a TXOP sharing access point, while an access point wireless device with which a TXOP is shared in such a way can be referred to herein as a TXOP shared access point, in some embodiments. Thus, in the example of FIG. 5, the first access point wireless device can act as a TXOP sharing access point, while the second access point wireless device can act as a TXOP shared access point. It should be noted, though, that such roles are not necessarily fixed, and that an access point can be capable of acting as a TXOP sharing access point at one time and a TXOP shared access point at another time, at least according to some embodiments. For example, an access point could act as a TXOP sharing access point for CBF sounding and a TXOP shared access point for a CBF data frame exchange sequence, in some embodiments.

The second access point wireless device can transmit, to the first access point wireless device, an initial control response (ICR) frame, e.g., in response to the ICF (504). The ICR can indicate a (“second”) duration that is configured for use in determining the NAV, which can also be configured to protect one or more CBF sounding sequences in the TXOP. In some instances, endpoint of the NAV that can be derived from the indication of the second duration in the ICR and the endpoint of the NAV that can be derived from the indication of the first duration in the ICF can match, for example to provide protection for the CBF sounding sequence(s) both from those wireless devices within range of the first access point wireless device and those wireless devices within range of the second access point wireless device, at least according to some embodiments. The ICF and ICR can also carry information that is used to configure subsequent frames in the sounding sequence, such as the payload of one or more of null data packet announcement (NDPA) frames, null data packets (NDPs), and/or beamforming report poll (BFRP) frames.

The first access point wireless device and the second access point wireless device can perform one or more CBF sounding frame exchanges with one or more non-access point wireless devices (506). For example, a CBF sounding frame exchange can be performed with a non-access point wireless device that is associated with one of the first access point wireless device or the second access point wireless device. Additional CBF sounding frame exchanges can be performed with additional wireless devices (e.g., one or more additional non-access point wireless devices that are associated with the first access point wireless device or the second access point wireless device), in some embodiments.

The CBF sounding frame exchange can include a joint CBF sounding frame exchange, in some embodiments. In this approach, it can be the case that null data packet (NDP) transmission is performed concurrently by the first access point wireless device and the second access point wireless device. For example, after the ICF/ICR exchange between the first access point wireless device and the second access point wireless device, the first access point wireless device can perform an ICF/ICR exchange with a non-access point wireless device associated with one of the first access point wireless device or the second access point wireless device and provide a NDP announcement (NDPA) frame. After the NDPA, the first access point wireless device and the second access point wireless device can transmit (concurrently in time) NDP frames, which can be received by the non-access point wireless device. The first access point wireless device can then provide a beamforming report poll (BFRP) frame to the non-access point wireless device, which can in turn respond with a beamforming report (BFR) frame to provide beamforming reporting information for both the first access point wireless device and the second access point wireless device based at least in part on the NDP frames provided by the first access point wireless device and the second access point wireless device. Similar joint CBF sounding operations can be performed with other non-access point wireless devices associated with the first access point wireless device or the second access point wireless device, according to some embodiments.

As another possibility, the CBF sounding frame exchange can include a sequential CBF sounding frame exchange, in some embodiments. In this approach, it can be the case that NDP transmission is performed sequentially by the first access point wireless device and the second access point wireless device. For example, the first access point wireless device can perform an ICF/ICR exchange with a non-access point wireless device associated with one of the first access point wireless device or the second access point wireless device and provide a NDPA frame. After the NDPA, the first access point wireless device can transmit an NDP frame, which can be received by the non-access point wireless device. The first access point wireless device can then provide a BFRP frame to the non-access point wireless device, which can in turn respond with a BFR frame to provide beamforming reporting information for the first access point wireless device based at least in part on the NDP frame provided by the first access point wireless device. To obtain sounding information for the non-access point wireless device for the second access point wireless device, the first access point wireless device can perform another ICF/ICR exchange with the non-access point wireless device, if needed, and provide another NDPA frame. After this NDPA, the second access point wireless device can transmit an NDP frame, which can be received by the non-access point wireless device. The first access point wireless device can then provide a BFRP frame to the non-access point wireless device, which can in turn respond with a BFR frame to provide beamforming reporting information for the second access point wireless device based at least in part on the NDP frame provided by the second access point wireless device. Similar sequential CBF sounding operations can be performed with other non-access point wireless devices associated with the first access point wireless device or the second access point wireless device, according to some embodiments.

For concurrent NDP transmission from multiple access points for joint sounding, it can be important for both access points to set the BSS color indicator to the same value, e.g., so that the physical layer (PHY) preambles are aligned. For sequential sounding as well, for a non-access point wireless device associated with one access point wireless device to decode/filter a NDP from the other access point wireless device, the BSS color to be used may need to be well defined.

Accordingly, as one possibility, it can be the case that a BSS_COLOR indicator is set to 0 in the PHY preamble of the NDP for the CBF sounding. This can be a special BSS_COLOR value specified for this use. A different special BSS_COLOR value could also or alternatively be specified for this use. As another possibility, a TXOP shared AP can be configured to use the BSS_COLOR value associated with the TXOP sharing AP in the PHY preamble of the NDP for CBF sounding; for example, the second access point wireless device could transmit a NDP for the CBF sounding with a BSS_COLOR indicator set to the BSS_COLOR value associated with the first access point wireless device in the PHY preamble of the NDP, according to some embodiments. As a further possibility, the BSS_COLOR value of the TXOP shared AP can be used in the PHY preamble of the NDPs from both access point wireless devices for the CBF sounding, according to some embodiments.

Similar options can be used for BSS_COLOR indication for BFR generation and transmission by non-access point wireless devices participating in CBF sounding operations, according to some embodiments. For example, the second access point wireless device could receive a BFR frame from a non-access point wireless device that is associated with the first access point wireless device, which includes a BSS_COLOR indicator set to 0 in the PHY preamble of the BFR frame, and decode the BFR frame based at least in part on the BSS_COLOR indicator being set to 0 in the PHY preamble of the BFR frame. As another possibility, the second access point wireless device could receive a BFR frame from a non-access point wireless device that is associated with the first access point wireless device, which includes a BSS_COLOR indicator set to the BSS_COLOR value associated with the first access point wireless device in the PHY preamble of the BFR frame, and decode the BFR frame based at least in part on the BSS_COLOR indicator being set to the BSS_COLOR value associated with the first access point wireless device in the PHY preamble of the BFR frame. As a further possibility, the BSS_COLOR value associated with the second access point wireless device can be used in the PHY preamble of the BFR frame, and both access point wireless devices can be configured to decode the BFR frame based at least in part on the BSS_COLOR indicator being set to the BSS_COLOR value associated with the second access point wireless device, according to some embodiments.

Note that it can be the case that a different type of BSS_COLOR indication can be used in the BFR frame than in the NDP frames, in some embodiments; for example, a BSS_COLOR indicator can be set to 0 in the PHY preamble of the NDPs for the CBF sounding for a non-access point wireless device, and the BSS_COLOR indicator can be set to the BSS_COLOR value of the associated access point wireless device for the non-access point wireless device in the PHY preamble of the BFR frame for the CBF sounding for the non-access point wireless device, in some embodiments. Other combinations are also possible.

It can be useful to provide a framework for providing failure notification and recovery for CBF sounding operations. For example, in case the second access point wireless device detects any errors or special conditions that could affect CBF data exchange operations with the first access point wireless device, such a framework can allow the second access point wireless device to notify the first access point wireless device to stop CBF transmission, and/or to take remedial action to continue the CBF transmission.

One approach that can be used for such error reporting can be for the second access point wireless device to provide an unsolicited error report frame after a CBF sounding frame exchange sequence. Another approach could be for the second access point wireless device to provide CBF sounding failure reporting information in a CBF response frame that the second access point wireless device provides in response to a CBF announcement frame provided by the first access point wireless device, for example when the first access point wireless device is initiating, scheduling, or otherwise communicating regarding a CBF data frame exchange. Still another possibility could include for the second access point wireless device to provide CBF sounding failure reporting information in an ICF provided by the second access point wireless device. For example, after the first access point wireless device initiates a CBF data frame exchange with the second access point wireless device with its own ICF, the second access point wireless device can provide CBF sounding failure reporting information to the first access point wireless device in an ICF. In case the second access point wireless device determines to cancel the CBF data frame exchange due to the CBF sounding failure reporting information, this ICF can be addressed to the first access point wireless device, based on which the first access point wireless device can continue to use the remaining TXOP without the second access point wireless device, at least according to some embodiments.

Note that the CBF sounding failure reporting information could relate to any of various aspects of CBF sounding. In some embodiments, an error condition associated with NDP transmission during CBF sounding could be provided. As another possibility, an error condition associated with BFR transmission during CBF sounding could be provided. In some instances, an address change for a non-access point wireless device included in CBF sounding could be reported on as CBF sounding failure reporting information; in this case, remedial information such as updated address information for the non-access point wireless device could also be provided. Other types of CBF sounding failure reporting information are also possible.

Note that in some embodiments, it can be possible for a non-access point wireless device or an access point wireless device to opt-out of CBF operation, e.g., including CBF sounding and/or CBF data frame exchange operations. For example, a wireless device could determine that lower power consumption is a higher priority than high data throughput, and accordingly determine to opt-out of CBF operation. Other reasons for determining to opt-out of CBF operation are also possible. For such a non-access point wireless device, it can be possible to provide an indication to its associated access point wireless device to opt out of CBF operation. Such an indication could be provided in any of various ways, such as in a management frame, an A-Control field in a data or management frame, a control frame, etc.

Thus, according to the method of FIG. 5, it can be possible to perform CBF sounding in a manner that includes NAV protection for all of the BSSs involved, as well as provides error reporting and handling options, opt-out signaling, and BSS_COLOR signaling coordination, which can greatly increase the robustness of such operation, at least according to some embodiments.

Once CBF sounding has been performed, e.g., such that a set of access point wireless devices have sounding information to enable formation of beam and null signals to one or more associated non-access point wireless devices, one or more CBF data frame exchange sequences can be performed.

There can be multiple possible approaches to structuring a CBF data frame exchange sequence, according to various embodiments. As one possibility, a staggered ICF/ICR approach can be used, in which a sharing access point performs an ICF/ICR exchange with an associated non-access point wireless device, then subsequently a shared access point performs an ICF/ICR exchange with an associated non-access point wireless device. The sharing access point and the shared access point can then transmit CBF data frames in a coordinated manner and receive block acknowledgement frames from the recipient wireless devices.

In this approach, it can be the case that an indication is provided to the non-access point wireless device associated with the sharing access point (e.g., by the sharing access point, in the ICF provided to the associated non-access point wireless device, or in another ICF, or in a CBF announce frame, or in a CBF sync frame, among various possibilities) to continue monitoring the wireless link for a CBF data frame after detecting a CBF ICF from the shared access point. The indication can include an identifier for the wireless device, such as an association identifier. This can prevent an enhanced multi-link single radio (eMLSR) device from switching its radio operation in a manner that would prevent effective reception of the CBF data frame. Such an indication could indicate a time duration or a number of physical layer protocol data units to continue monitoring on the wireless link, among various possibilities. Note that in this case, the sharing access point can also be configured not to attempt to transmit to the non-access point associated with the sharing access point on a different link (e.g., if that non-access point wireless device is an eMLSR wireless device) for the configured duration, at least according to some embodiments.

Similar operations can be applicable to the shared access point and the non-access point wireless device associated with the shared access point, in some embodiments. For example, the shared access point can indicate a time duration for the non-access point wireless device associated with the shared access point to remain on the link in a ICF transmitted by the shared access point. In this case, the shared access point wireless device can also be configured not to attempt to transmit to that non-access point wireless device on a different link (e.g., if that non-access point wireless device is an eMLSR wireless device) for the configured duration, at least according to some embodiments.

In some embodiments, NAV protection for the ICF from each AP can be left to AP implementation choice. One possibility can include supporting indication in an ICF of a duration that is configured for use in determining a NAV that provides protection until an end of BA frame(s) of the CBF sequence, which can also be referred to as a ‘long NAV protection’ case herein. In this scenario, it can be the case that a carrier sensing required subfield of the ICF can be set to 0, e.g., such that carrier sensing need not be performed before transmission of any ICR frames that are provided in response to the ICF.

It can also be the case that an indication can be provided by the sharing access point and/or the shared access point to disallow non-primary channel access (NPCA) during the CBF data frame exchange sequence, in some embodiments. For example, such an explicit indication could be provided in an ICF, ICR, announce, response, and/or sync frame, in various scenarios.

Additionally, it can be the case that the wireless devices involved in a CBF data frame exchange sequence structured in such a manner can be configured with one or more NAV rule exceptions, e.g., such that NAV protection can be provided for both basic service sets involved in the CBF data frame exchange sequence without preventing the CBF data frame exchange sequence from being performed altogether. For example, the sharing access point can be configured with one or more NAV exceptions to allow transmission of one or more of ICF, ICR, sync, CBF data, or BA frames during a NAV set by a wireless device that is associated with a basic service set not provided by the sharing access point and that is participating in a CBF data frame exchange sequence with the sharing access point wireless device, such as the shared access point wireless device, a non-access point that is associated with the shared access point wireless device, etc. Similarly, the shared access point can be configured with one or more NAV exceptions to allow transmission of one or more of ICF, ICR, sync, CBF data, or BA frames during a NAV set by a wireless device that is associated with a basic service set not provided by the shared access point and that is participating in a CBF data frame exchange sequence with the shared access point wireless device, such as the sharing access point wireless device, a non-access point that is associated with the sharing access point wireless device, etc. For a non-access point wireless device, one or more NAV exceptions can be configured to allow transmission of one or more of ICR or BA frames during a NAV set by a wireless device that is not associated with a basic service set of the non-access point wireless device and that is participating in a CBF data frame exchange sequence with the non-access point wireless device. For example, for a non-access point wireless device associated with the sharing access point, these could include the shared access point wireless device, a non-access point wireless device that is associated with the shared access point wireless device, etc., while for a non-access point wireless device associated with the shared access point, these could include the sharing access point wireless device, a non-access point wireless device that is associated with the sharing access point wireless device, etc. Note that other NAV exceptions can also or alternatively be implemented in conjunction with a CBF data frame exchange sequence that uses a staggered ICF/ICR structure, according to various embodiments.

Use of such a staggered ICF/ICR structure can potentially introduce multiple possibilities for failure, failure handling, and failure recovery. For example, scenarios could be possible in which any of the ICR from the non-access point wireless device associated with the sharing access point, the ICF from the shared access point, or the ICR from the non-access point wireless device associated with the shared access point can fail. Accordingly, failure handling/recovery techniques for such scenarios can be provided, in some embodiments.

As one such technique, in case ICR failure from the non-access point wireless device associated with the sharing access point occurs, the shared access point can abort its ICF transmission. To facilitate such operation, the shared access point can also monitor the ICR from the non-access point wireless device associated with the sharing access point.

As another such technique, in case no CBF ICF is received from the shared access point, the sharing access point can perform an in-basic service set data transmission. In other words, the sharing access point can abort the CBF data frame exchange sequence but continue with a non-CBF data transmission in this case, at least according to some embodiments.

As a further such technique, in case ICR failure from the non-access point wireless device associated with the shared access point occurs, the sharing access point can adjust its CBF data frame or transmit a non-CBF data frame instead of the CBF data frame. It can also be possible for the sharing access point to continue with the original CBF data frame in such a scenario, in some embodiments. Note that the sharing access point can detect such an ICR failure directly, e.g., by monitoring the ICR from the non-access point wireless device associated with the shared access point, or the shared access point can notify the sharing access point about such a failure (e.g., with PIFS recovery), according to various embodiments.

Another approach to structuring a CBF data frame exchange sequence can include use of a multi-user initial control frame, in which a sharing access point performs a multi-user ICF/ICR exchange with multiple non-access point wireless devices, and possibly also with the shared access point, at the same time. The sharing access point and the shared access point can then transmit CBF data frames in a coordinated manner and receive block acknowledgement frames from the recipient wireless devices. This approach can potentially avoid at least some of the additional complexity introduced by a CBF data frame exchange sequence structure that includes a staggered ICF/ICR approach, according to some embodiments.

FIG. 6 is a flowchart diagram illustrating a method for performing such an approach to coordinated beamforming data operation in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 6 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 6 are described in a manner relating to the use of communication techniques and/or features associated with IEEE 802.11 specification documents, such description is not intended to be limiting to the disclosure, and aspects of the method of FIG. 6 can be used in any suitable wireless communication system, as desired. As shown, the method can operate as follows.

A first access point wireless device can transmit an ICF for a CBF data frame exchange sequence (602) that is addressed to multiple users. Since the ICF can be addressed to multiple users, in some embodiments, the ICF can also be referred to as a multi-user ICF or MU ICF herein. The ICF can be addressed to one or more non-access point wireless devices, for example including a first non-access point wireless device that is associated with the first access point wireless device, and a second non-access point wireless device that is associated with a second access point wireless device. The first access point wireless device can act as a TXOP sharing access point, while the second access point wireless device can act as a TXOP shared access point, in the example scenario of FIG. 6. The ICF can indicate a duration that is configured for use in determining a NAV, which can be configured to protect the remainder of the CBF data frame exchange sequence. It can also be possible that a duration indicated in the ICF is configured for use in determining a NAV that protects only a portion of the CBF data frame exchange sequence. Such shorter NAV protection can be useful, for example, to avoid blocking medium use by the second access point wireless device in case the CBF data frame transmission is ultimately performed without participation by the second access point wireless device.

The first access point wireless device can receive one or more ICRs in response to the ICF for the CBF data frame exchange sequence. At least in some embodiments, the ICRs can be received concurrently, e.g., effectively as a multi-user uplink frame. For example, the first access point wireless device can receive an ICR from each of the first non-access point wireless device and the second non-access point wireless device, in some embodiments.

In some embodiments, the ICF can also be addressed to the second access point wireless device. For example, the second access point wireless device can be addressed if the first access point wireless device determines to solicit an ICR from the second access point wireless device for better NAV protection. In this case, the first access point wireless device can receive an ICR from the second access point wireless device.

The ICF can provide information to the non-access point wireless devices participating in the CBF data frame exchange sequence to facilitate effective reception of a CBF data frame. In some embodiments, this can include providing associated access point identifier information (such as BSS_COLOR, or another access point identifier, such as the full MAC address of the access point, or a short identifier (e.g. only 11 or 12 bits to identify the AP for airtime efficiency)) and association identifier (AID) information for those non-access point wireless devices. Providing both associated access point identifier information and AID information can help avoid uncertainty in case participating non-access point wireless devices associated with different BSSs have the same AID. Thus, in some embodiments, the ICF can include access point identifier information and AID information for the first non-access point wireless device and the second non-access point wireless device. In some embodiments, the access point identifier information and AID information can be indicated explicitly as tuples. In some embodiments, the access point associated with a non-access point wireless device for which information is provided in the ICF can be indicated implicitly, e.g., based on a location of the AID information for the non-access point within the ICF. For example, AIDs of devices associated with a sharing access point could be placed earlier in the ICF and AIDs of devices associated with a shared access point could be placed later in the ICF, with a splitting point indicated in the ICF, as one possibility. As another example, access point identifier information for a shared access point or AIDs of devices associated with the shared access point could be placed earlier in the ICF and AIDs of devices associated with a sharing access point could be placed later in the ICF, with a splitting point indicated in the ICF. One example to indicate the splitting point could include inserting a User Info field whose AID12 contains a short identifier of the shared access point, immediately after all of the User Info fields for the devices associated with the sharing access point. Another example to indicate the splitting point could include inserting a User Info field whose AID12 contains a short identifier of the shared access point in the beginning portion of the User Info list in the ICF, and the content of the User Info field can indicate the splitting point, e.g., in terms of a counter of User Info fields, or a byte count, among various possibilities.

In some embodiments, the ICF can additionally or alternatively assign one or more CBF specific values to participating non-access point wireless devices for the CBF data frame exchange sequence. For example, one or more of a CBF specific associated access point identifier (e.g., CBF specific BSS_COLOR, which could be different than the BSS_COLOR of a BSS provided by either the first access point wireless device or the second access point wireless device) or a CBF specific AID could be assigned to the one or more of the first non-access point wireless device or the second non-access point wireless device. Such assignment can potentially aid the non-access point wireless devices to decode a CBF data frame provided during the CBF data frame exchange sequence, at least according to some embodiments.

In some embodiments, the ICF can provide CBF specific transmitter address (TA) and/or CBF specific receiver address (RA) information. For example, one or more TA and/or RA values can be specified for use for CBF operation in wireless communication standard specifications. In this case, non-access point wireless devices receiving the ICF can be configured to recognize that use of such a TA and/or RA in the ICF is indicative that the ICF is initiating a CBF data frame exchange sequence and filter the frame accordingly.

Note that any of various possible frame formats can be used for the ICF and ICR frames, according to various embodiments. As one possibility, a frame format that is based on a multi-user request to send (MU-RTS) frame can be used as the ICF. Similarly, a frame format that is based on a clear-to-send (CTS) frame can be used for the ICR frames. Other options, including frame formats based on buffer status report poll (BSRP) and buffer status report (BSR) frame formats, newly defined trigger and/or response frames, and/or any of various other possible frame formats, can also be used.

In some embodiments, a CBF announce frame and CBF response frame exchange can be performed by the first access point wireless device and the second access point wireless device (e.g., prior to transmission of the ICF), for example to coordinate scheduling for the CBF data frame exchange sequence (e.g., for the second access point wireless device to indicate intention to participate, for the first and second access point wireless devices to indicate/select participating non-access point wireless devices, to negotiate parameters (e.g., preamble settings) for the CBF data frame, how to schedule block acknowledgement frames, etc.). Thus, it can be the case that the ICF is transmitted based at least in part on the CBF announce frame and CBF response frame exchange. In some embodiments, it can be possible for a CBF announce frame and CBF response frame exchange to be performed between more than two access point wireless devices, for example in a scenario in which CBF data exchange can be scheduled and performed between three or more access point wireless devices. It can also or alternatively be possible that the CBF announce frame and CBF response frame exchange can be performed in a manner that includes one or more non-AP wireless devices. For example, the CBF announce frame can further solicit a response frame from the first non-access point wireless device, in some embodiments. In this case, the first access point can also receive a CBF response frame from the first non-access point wireless device. The CBF announce frame can thus include a multi-user trigger frame, and the response(s) can include a trigger-based frame, in some embodiments, in some embodiments. A clear-to-send (CTS) CBF response frame can be used as another possibility. In some instances, non-high-throughput duplicate (non-HT dup) frames can be used for the CBF response frame(s).

The first access point wireless device and the second access point wireless device can maintain NAV protection throughout the CBF data frame exchange sequence, at least according to some embodiments. For example, the CBF announce frame could indicate a (“first”) duration that is configured for use in determining a NAV that provides protection until the start of the ICF, the CBF response frame could indicate a (“second”) duration that is configured for use in determining a NAV that provides protection until the start of the ICF frame or the CBF data frame, and the ICF could indicate a (“third”) duration that is configured for use in determining a NAV that provides protection until the end of one or more block acknowledgement frames that complete the CBF data frame exchange sequence. As previously noted herein, in some instances, an ICR provided by the second access point wireless device (e.g., if solicited) can also provide NAV protection until the end of the one or more block acknowledgement frames that complete the CBF data frame exchange sequence.

There can be multiple options for handling security for the CBF data frame exchange sequence, according to various embodiments. In particular, since devices associated with multiple BSSs can be involved in the CBF data frame sequence, it can be useful to provide techniques for a non-access point wireless device to recognize when to respond to a communication from an access point device with which the non-access point is not associated. For example, it can be important to provide a way for the second non-access point wireless device to identify whether the ICF from the first non-access point wireless device is a valid frame and whether to respond with an ICR frame, considering that the second non-access point wireless device is associated with the second access point wireless device rather than the first access point wireless device.

As one possibility, the CBF response frame provided by the second access point wireless device can include security fingerprint information for the second non-access point wireless device (e.g., generated based on a key between the second access point wireless device and the second non-access point wireless device), based at least in part on which the second non-access point device can determine to respond to the following ICF (e.g., if validation is successful). Thus, in this case, the second non-access point can decode the CBF response frame directly to obtain this fingerprint information.

As another possibility, the CBF response frame can similarly carry such fingerprint information, and the first access point wireless device can rebroadcast the fingerprint in the following ICF. In this case, the second non-access point may not need to decode the CBF response frame to obtain this fingerprint information, and can validate the fingerprint in the ICF using the key between the second non-access point wireless device and the second access point wireless device to determine whether to respond to the ICF.

A further possibility can include defining a shared key across the two BSSs. In other words, a shared key can be defined across the first access point wireless device and the second access point wireless device (e.g., together with CBF scheduling and parameter negotiation during the CBF announce/response exchange, as one possibility), for example for use in the CBF data frame sequence. In this case, the first access point wireless device can include security fingerprint information for the second non-access point wireless device in the ICF that is based on this shared key, and the second non-access point wireless device can use the shared key to validate the ICF and determine whether to respond to the ICF.

The first access point wireless device can a transmit CBF data frame (606). The second access point wireless device can also transmit a CBF data frame, concurrently in time with the CBF data frame transmitted by the first access point wireless device. At least in some embodiments, the CBF data frames transmitted by the first access point wireless device and the second access point wireless device can occupy the same bandwidth. If preamble puncturing is used in CBF data transmissions, the same puncturing pattern can be used. This approach can avoid introducing additional complexity for joint sounding and nulling operations, at least in some embodiments.

At least according to some embodiments, the CBF data frame transmission by the first access point wireless device can include beamforming a CBF data frame to the first non-access point wireless device, and nullforming to the second non-access point wireless device, e.g., to reduce potential interference effects on the second non-access point wireless device from the transmission of the CBF data frame to the first non-access point wireless device. In a similar manner, the CBF data frame transmission by the second access point wireless device can include beamforming a CBF data frame to the second non-access point wireless device, and nullforming to the first non-access point wireless device, e.g., to reduce potential interference effects on the first non-access point wireless device from the transmission of the CBF data frame to the second non-access point wireless device. This coordinated beamforming between the sharing access point wireless device and the shared access point wireless device can thus improve the signal quality at each of the recipient wireless devices, at least according to some embodiments.

The CBF data frames transmitted by the first access point wireless device and the second access point wireless device can be transmitted with the same PHY preamble, at least in part. For example, in some embodiments, the PHY preambles can be aligned (e.g., for an initial non-beamformed portion) through a UHR-SIG field. Aligning the (e.g., at least initial portions of the) PHY preambles can assist wireless devices that are not part of the CBF data frame sequence to decode them for relevant information, at least according to some embodiments. Beamformed portions with spatial nulling, which can possibly also include one or more PHY preamble fields such as UHR-STF and/or UHR-LTF fields, can be provided after the aligned non-beamformed PHY preamble portions of the CBF data frames, in some embodiments.

The PHY preambles can also include information to facilitate identification of resource unit (RU) allocation and/or other relevant for each of the target recipient wireless devices. This can include providing at least one of CBF specific associated access point identifier information (e.g., CBF specific BSS_COLOR) or CBF specific non-access point wireless device identifier information for one or more of the first non-access point wireless device or the second non-access point wireless device, in some embodiments. For example, if CBF specific BSS_COLOR or CBF specific wireless device identifier information is assigned earlier in the CBF data frame sequence (e.g., in the announce frame, ICF, in a sync frame, etc.), those values can then be used to identify which information is for which wireless device in the CBF data frame preamble.

As another possibility, both associated access point identifier information (e.g., BSS_COLOR or another indicator) and non-access point wireless device identification information (e.g., STA-ID) can be used to provide RU allocation and/or otherwise identify which information is for which wireless device in the CBF data frame preamble. Using both types of information can be another way to avoid possible ambiguity in case wireless devices associated with different BSSs have the same in-BSS wireless device identification information. In some embodiments, instead of or in addition to BSS_COLOR, it can be possible to use a shorthand indication of the associated access point identifier information. For example, a 1-bit BSS indicator could be defined such that a value of ‘0’ indicates that a wireless device associated with a sharing access point (e.g., the first access point wireless device) is signaled, while a value of ‘1’ indicates that a wireless device associated with a shared access point (e.g., the second access point wireless device) is signaled.

A further possibility can include the use of multiple content channels in the PHY preamble. For example, a first content channel (e.g., a 20 MHz subchannel) can provide RU allocation information for a BSS provided by the first access point wireless device, while a second content channel can provide RU allocation information for a BSS provided by the second access point wireless device.

At least according to some embodiments, the PHY preamble can also include PHY protocol data unit (PPDU) type information that can indicate that the CBF data frame is a CBF PPDU. Note that it can also be possible that a partial bandwidth CBF data frame can be transmitted, in some embodiments. For example, the first access point wireless device and the second access point wireless device can concurrently transmit on a CBF bandwidth portion of the partial bandwidth CBF data frame, while only the first access point wireless device transmits on a non-CBF bandwidth portion of the partial bandwidth CBF data frame. If such partial bandwidth CBF data frame transmission is supported, the PHY preamble PPDU type field can include a value configured to indicate that the CBF data frame is a partial bandwidth CBF data frame, in some embodiments.

There can be numerous possibilities for how to structure the PHY preamble to provide the various possible types of information described herein. Several such specific example possibilities are described in the following section. It should be noted, however, that numerous variations and alternatives are possible. As one possibility, it can be the case that a 3-bit subfield across U-SIG1 and U-SIG2 (e.g., bit 25 (a validate bit) of the U-SIG1 field and bits 0-1 of the U-SIG2 field) of the PHY preamble are configured to indicate the CBF PPDU type for the CBF data frame. In case the CBF data frame is a partial bandwidth CBF data frame, bit 25 of the U-SIG1 field and bits 0-1 of the U-SIG2 field of the PHY preamble can indicate that the CBF PPDU type for the CBF data frame is a partial bandwidth CBF data frame. Also in this case, a user field for a non-access point wireless device allocated a second bandwidth half of the partial bandwidth CBF data frame can be the last user field of the PHY preamble, and can have an orthogonal frequency division multiple access (OFDMA) format. As another possibility, the CBF data frame can be a partial bandwidth CBF frame, in which bits a 2-bit subfield (e.g., bits 19-20) of a UHR SIG common field of the PHY preamble indicate that the CBF PPDU type for the CBF data frame is a partial bandwidth CBF data frame. A 6-bit subfield (e.g., bits 0-5) of the UHR SIG common field of the PHY preamble can indicate the BSS_COLOR of the shared access point wireless device for the CBF data frame, and a 2-bit subfield (e.g., bits 17-18) of the UHR SIG common field of the PHY preamble can indicate a total number of non-OFDMA users addressed in the CBF data frame, in this case, at least according to some embodiments. In some instances, bits 7-12 of a U-SIG1 field of the PHY preamble can be configured to indicate a BSS_COLOR of a sharing access point wireless device for the CBF data frame. As another possibility, a 6-bit subfield (e.g., bits 0-5) of the UHR-SIG common field of the PHY preamble can be configured to indicate a BSS_COLOR of a shared access point wireless device for the CBF data frame. As still another possibility, a 2-bit subfield (e.g., bits 17-18) of a UHR-SIG common field of the PHY preamble can be configured to indicate a total number of users addressed in the CBF frame. As yet another possibility, bits 20-25 of a U-SIG1 field of the PHY preamble can be configured to indicate a BSS_COLOR of a shared access point wireless device for the CBF frame. As a still further possibility, a reserved bit (e.g., bit 20) of each user field of the PHY preamble can be configured to indicate an associated access point wireless device for a non-access point wireless device. In some embodiments, a UHR-SIG modulation and coding scheme (MCS) field of the PHY preamble (e.g., bits 9-10 of U-SIG2) can be set to 0, e.g., to indicate that UHR-MCS0 is used for the UHR-SIG field. This can be helpful due to possible timing synchronization error between a sharing access point and a shared access point, e.g., to provide a robust MCS for more reliable decoding of the UHR-SIG.

One or more block acknowledgement (BA) frames can be received in response to the CBF data frame(s) (608). For example, the first access point wireless device can receive a BA frame at least from the first non-access point wireless device, while the second access point wireless device can receive a BA frame at least from the second non-access point wireless device. The BA frames can be received concurrently in time using orthogonal frequency division multiple access (OFDMA), in some embodiments. In some embodiments, the BA information for the second non-access point wireless device can be provided from the first access point wireless device to the second access point wireless device via a backhaul link. Such an arrangement can be negotiated as part of the CBF announce/response exchange and/or such frames can be solicited by the CBF data frame, according to various embodiments. As another possibility, the BA frames can be received staggered in time. For example, the first access point wireless device can provide a BA request (BAR) frame after the CBF PPDU to solicit a BA from the first non-access point wireless device and receive the BA from the first non-access point wireless device, then the second access point wireless device can provide a BAR frame to solicit a BA from the second non-access point wireless device and receive the BA from the second non-access point wireless device. In some embodiments, a cross-BSS trigger frame can be provided to solicit such staggered BA transmission from the first non-access point wireless device and the second non-access point wireless device. The cross-BSS trigger frame could, for example, include identification information for the first non-access point wireless device and the second non-access point wireless device, e.g., to prevent them from returning to eMLSR listening operation.

Thus, according to the method of FIG. 6, it can be possible to perform a coordinated beamforming data frame exchange sequence including a multi-user initial control frame, which can provide effective security, NAV protection, and signaling across multiple basic service sets involved in the sequence, among various possible benefits, at least according to some embodiments.

According to some embodiments, it can also be possible to perform a coordinated spatial reuse (C-SR) frame exchange sequence using similar techniques. According to some embodiments, for example, an announce/response frame exchange can be performed between a first access point wireless device, a second access point wireless device, and possibly one or more other access point and/or non-access point wireless device, e.g., to solicit interest indication(s), to negotiate scheduling and other configuration parameters, etc. As part of the announce/response frame exchange, the first access point wireless device can transmit an announce frame for a C-SR data frame exchange sequence, which can be addressed to at least the second access point wireless device. The announce frame can indicate whether it is for a C-SR or CBF data frame exchange sequence, for example in scenarios in which the same announce frame structure can be used for announce/response frame exchanges for both C-SR and CBF data frame exchange sequences. The first access point wireless device can receive a response frame for the C-SR data frame exchange sequence from the second access point wireless device and/or one or more other access point and/or non-access point wireless devices.

The first access point wireless device can transmit a first ICF for the C-SR data frame exchange sequence, which can be addressed to at least a first non-access point wireless device that is associated with the first access point wireless device. The first access point wireless device can receive an ICR frame from at least the first non-access point wireless device in response to the first ICF. The second access point wireless device can similarly transmit a second ICF for the C-SR data frame exchange sequence, which can be addressed to at least a second non-access point wireless device that is associated with the second access point wireless device. The second access point wireless device can receive an ICR frame from at least the second non-access point wireless device in response to the second ICF.

In some embodiments, either or both of the ICFs can also solicit an ICR from the other access point wireless device, in which case that access point wireless device can also provide an ICR. Thus, it can be the case that the first ICF is also addressed to the second access point wireless device, and that the first access point wireless device receives an ICR frame from the second access point wireless device in response to the first ICF. Similarly, it can be the case that the second ICF is also addressed to the first access point wireless device, and that the second access point wireless device receives an ICR frame from the first access point wireless device in response to the second ICF.

Note that it can be the case in a C-SR scenario that the first access point wireless device is not within range of the second non-access point wireless device, and/or that the second access point wireless device is not within range of the first non-access point wireless device. Accordingly, for determining transmission timing of the second ICF, as one possibility, the second access point wireless device can decode a duration indication in the first ICF, and determine the time to start transmission of the second ICF based on the decoded duration indication. As another possibility, if solicited by the first ICF, the second access point wireless device can respond with its ICR and determine to start transmission of the second ICF a configured amount of time (e.g., SIFS, as one possibility) afterward.

At least in some embodiments, a sync frame can also be used for the C-SR data frame exchange sequence. It can be the case that one or the other of the first access point wireless device or the second access point wireless device transmits the sync frame. In some embodiments, it can be the case that the access point wireless device that initiates the C-SR data frame exchange sequence (e.g., the first access point wireless device, which transmitted the C-SR announce frame) also transmits the sync frame. As another possibility, the access point wireless device that transmits the sync frame can be negotiated. In some embodiments, the access point wireless device that transmits the sync frame can be implicitly determined among the first access point wireless device and the second access point wireless device. For example, in some embodiments, it can be supported that one of the access points can indicate that it is serving a ‘legacy’ non-access point wireless device in the C-SR data frame exchange sequence. In such a scenario, it can implicitly be determined that that access point also transmits the sync frame. In some embodiments, the sync frame can be a trigger frame. In some other embodiments, the sync frame can be a CTS frame. The sync frame can carry additional parameters for the subsequent data and/or BlockAck transmissions and optionally include padding to give the other AP sufficient amount of time to prepare the subsequent data and/or BlockAck transmissions. The parameters for data transmission can include BSS Color, STA ID, TXOP duration, bandwidth, puncturing pattern, number of long training fields (LTFs), modulation and coding scheme (MCS), and/or other parameters.

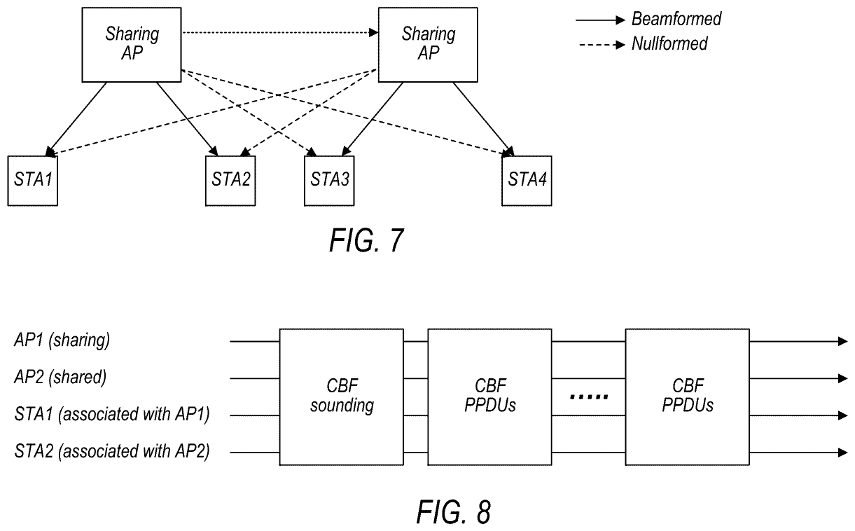

### FIGS. 7-37 and Additional Information

FIGS. 7-37 illustrate further aspects that might be used in conjunction with the methods of FIGS. 5-6. It should be noted, however, that the exemplary details illustrated in, and described with respect to, FIGS. 7-37 are not intended to be limiting to the disclosure as a whole: numerous variations and alternatives to the details provided herein below are possible and should be considered within the scope of the disclosure.

Concurrent coordinated beamforming and nulling transmissions from two or more APs can potentially provide increased network capacity in a wireless local area network setting. FIG. 7 illustrates example aspects of such possible transmissions, according to some embodiments. According to some embodiments, an AP that initiates a transmission opportunity (TXOP) and determines to share the TXOP with another AP through coordinated beamforming can be referred to herein as a “sharing” AP, while an AP with which a TXOP is shared for coordinated beamforming can be referred to herein as a “shared” AP. Other terminology for these roles is also possible. As shown, the sharing AP can send beamformed signals to associated STA1 and STA2 and nullformed signals to overlapping basic service set (OBSS) STA3 and STA4, e.g., to dampen the interfering effect of the transmissions to STA1 and STA2 on STA3 and STA4. The shared AP can coordinate to send beamformed signals to associated STA3 and STA4 and nullformed signals to OBSS STA1 and STA2, similarly to dampen the interfering effect of the transmissions to STA3 and STA4 on STA1 and STA2.

To accomplish such coordinated beamforming (CBF) operation, it can be the case that the APs perform sounding with candidate STAs for the CBF operation from time to time, and transmit subsequent CBF physical layer protocol data units (PPDUs) based on the sounding feedback. FIG. 8 illustrates an example timeline in which such CBF sounding and subsequent CBF PPDU transmission can occur among an AP1 (sharing), an AP2 (shared), a STA1 (associated with AP1), and a STA2 (associated with AP2), according to some embodiments.

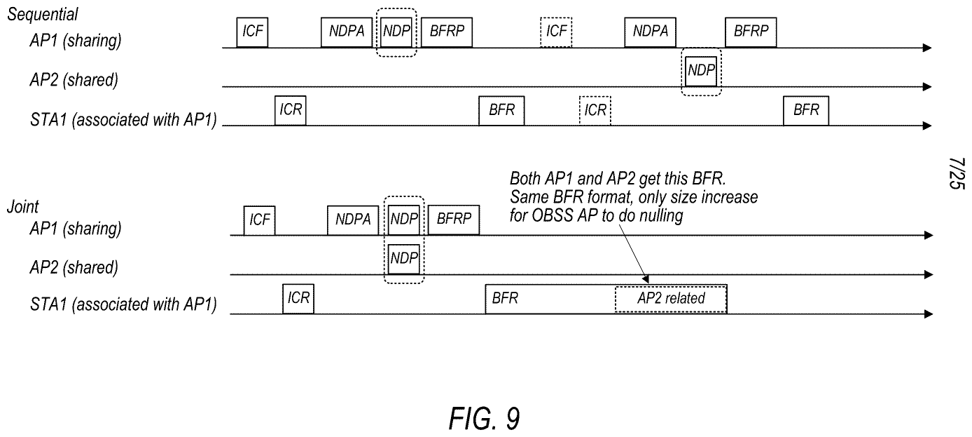

There can be multiple approaches to handling sounding timing for CBF. FIG. 9 illustrates two example timelines for two such approaches, for a scenario with an AP1 (sharing), an AP2 (shared) and a STA (associated with AP1), according to some embodiments. As shown, in a sequential approach, after initial control frame (ICF) and initial control response (ICR) exchange and null data frame announcement (NDPA), AP1 can provide a null data frame (NDP) and solicit a beamforming report (BFR) from STA1 using a BFR poll (BFRP) frame. Then, possibly after a further ICF/ICR exchange, AP1 can provide another NDPA, STA2 can provide an NDP, and AP1can provide a BFRP to solicit a BFR from STA1. Thus, AP1 and AP2 can perform sounding with STA1 in sequence. In a joint approach, after ICF and ICR exchange and NDPA, AP1 and AP2 can concurrently provide NDPs. AP1 can then provide a BFRP to solicit a BFR from STA1, and STA1 can provide a BFR that includes beamforming reporting information for both AP1 and AP2. In some instances, beamforming reporting using such joint sounding can result in better throughput, for example potentially for partial nulling, but can also possibly require higher capability on the STA side.

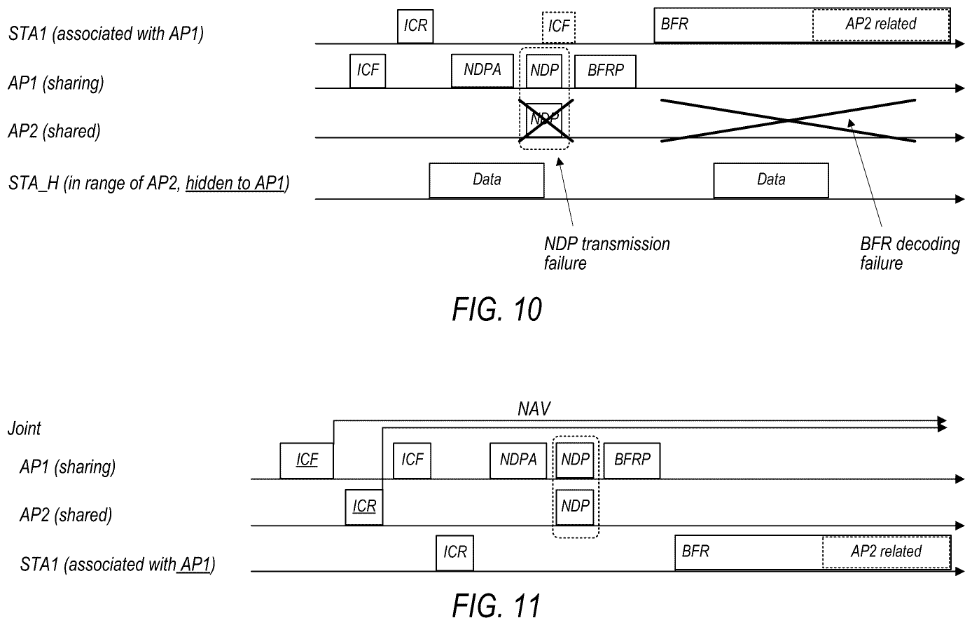

NDP transmission from the shared AP and/or BFR decoding at the shared AP in accordance with the sequences of FIG. 9 can, however, potentially be vulnerable to hidden node transmissions. FIG. 10 illustrates aspects of a scenario in which such hidden node interference can impact CBF sounding operation, according to some embodiments. As shown, a STA_H that is in range of AP2 but hidden to AP1 performs a transmission during the scheduled NDP transmission timing, which cause NDP transmission failure for the AP2 (e.g., clear channel assessment can fail, preventing AP2 from transmitting the NDP). As another possibility (and as also shown), such a hidden node transmission could also or alternatively interfere with reception of a BFR transmitted by STA1. Such interference can prevent effective CBF operation including AP2.

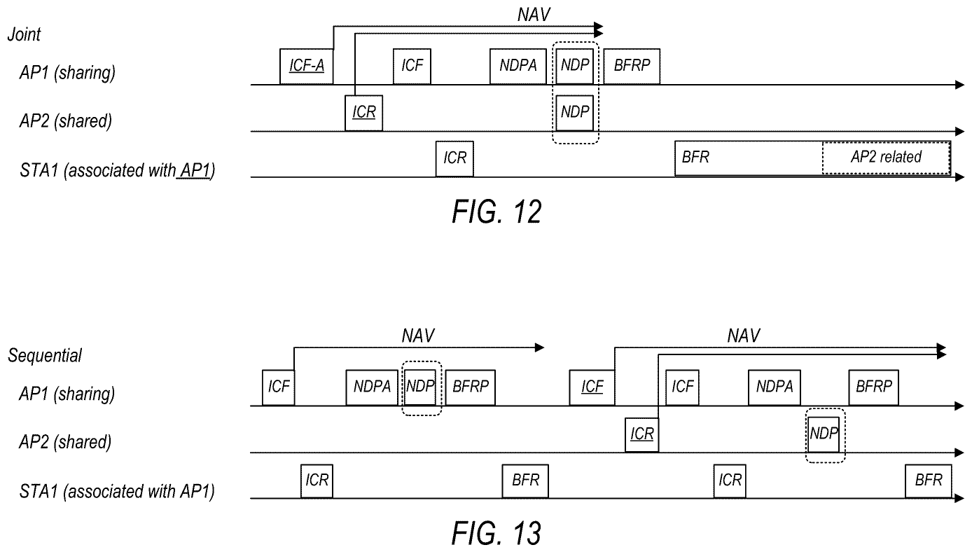

Accordingly, it can be beneficial to include NAV protection from both the sharing AP and the shared AP when performing CBF sounding, at least according to some embodiments. FIG. 11 illustrates example aspects of a possible joint sounding approach that includes NAV protection from both AP1 (sharing) and AP2 (shared) when performing CBF sounding with STA1 (associated with AP1). FIG. 12 illustrates example aspects of another possible joint sounding approach that includes NAV protection from both AP1 (sharing) and AP2 (shared) when performing CBF sounding with STA1 (associated with AP1, in which the NAV protection is provided until the start of the BFRP frame transmission. This approach can be used, for example, in case the AP2 can obtain the BFR via backhaul, e.g., to avoid overprotection, in some instances. FIG. 13 illustrates example aspects of a possible sequential sounding approach that includes NAV protection from both AP1 (sharing) and AP2 (shared) when performing CBF sounding with STA1 (associated with AP1).

As shown, control frame exchanges among APs to protect the NAV during CBF sounding can be used. Missing an ICR from AP2 in the illustrated scenarios could be an early indication of failure of the sounding sequence. It should be noted that NAV within a single TXOP can be set to protect more than one sounding sequence, each of which could be a joint or sequential sounding sequence. The ICF and ICR can also carry information that is used to configure subsequent frames in the sounding sequence, such as the payload of one or more of null data packet announcement (NDPA) frames, null data packets (NDPs), beamforming report poll (BFRP) frames, etc.

It can also be useful to provide procedures for one AP to notify another AP about sounding issues and/or sounding requests, possibly with one or more reason codes defined for providing further information. Such failure notification/recovery techniques can provide a way for a shared AP to report to a sharing AP if there is any failure in ICR response to ICF-A, NDP transmission from the shared AP, or BFR decoding at the shared AP. As one possibility, during the message exchange between APs in the TXOP for CBF PPDU, a shared AP can reject a sharing AP's request and indicate the lack of valid sounding info or request that the sharing AP redo the sounding.

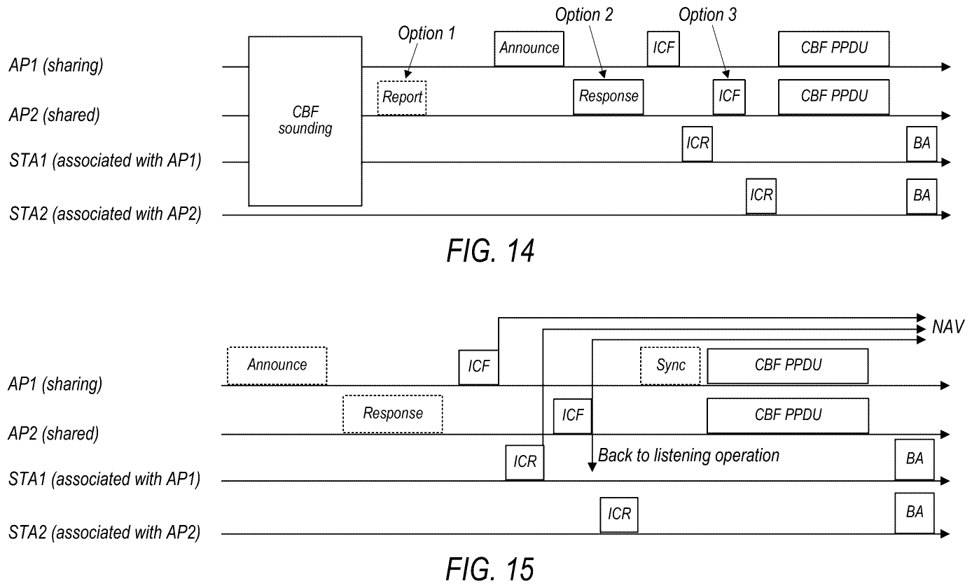

FIG. 14 illustrates further details of possible failure handling approaches for CBF sounding, according to some embodiments. As noted, if AP2 (shared) finds any errors or special conditions that preclude CBF being performed with AP1 (sharing) for some reason, it can be important to provide AP2 with a way to notify AP1 to stop the CBF transmission, and/or take remedial action to continue the CBF transmission.

As one option (e.g., the illustrated “Option 1”), the shared AP can send a report after CBF sounding, if any error condition is detected during CBF sounding, such as NDP or BFR issues, or if STA2 has changed its address (e.g., including association identifier (AID)). The report can also include remedy information, such as the updated address (e.g., which can include the AID) of STA2, so that AP1 can know which beamforming matrix to use to form nulls towards STA2.

As another option (e.g., the illustrated “Option 2”), after receiving an announce frame (e.g., a frame that solicits feedback from the shared AP on whether that AP wants to participate in CBF and/or more detailed information on the resource request such as priority or pending data) from the sharing AP1, the shared AP2 can also report similar information as in the case of Option 1 to the sharing AP1 in that frame.

As still another option (e.g., the illustrated “Option 3”), similar information as in the case of Option 1 can be provided in the ICF from the sharing AP2. In case the AP2 wants AP1 to cancel the CBF with AP1 and AP2, AP2 can potentially address the ICF to AP1, so that AP1 can continue using the remaining TXOP, at least in some instances.

In some instances, a device may have reason to not participate in CBF operation. For example, for some devices, it can potentially be determined to not participate in CBF operation that when battery reserves are low and high throughput is not of the highest priority. Accordingly, support for an AP and/or STA to opt out from CBF operation can be useful, at least in some embodiments. For AP operation, scheduling implementation can be used to handle such options, in some instances. For STA operation, a management frame such as an association or re-association frame can be used, or a new management frame (e.g., similar to an operation mode notification (OMN) frame) could include capability or preference information to indicate whether the STA opts in- or out-of CBF operation. An A-Control (e.g., operating mode indication (OMI)) field in a data or management frame, or a control frame such as ICR, can also potentially be used by a STA to indicate to opt-out of CBF operation, in some instances.

For concurrent NDPs from multiple APs for joint sounding, there can be multiple approaches to how to configure the preambles to be identical (e.g., to support OBSS detection and NAV setting) considering each AP can have a different BSS_COLOR parameter. For sequential sounding, for the STA associated with the first AP to decode/filter the NDP from the second AP, there can also be a need to define the BSS_COLOR use.

As one possibility, both APs can be configured to set the BSS_COLOR to 0 (or another pre-configured value) in the PHY preamble of the CBF sounding NDPs. STAs can corresponding be configured to be able to decode the NDP and provide the subsequent BFR when such a BSS_COLOR indication is used for CBF sounding operation.

As another possibility, the BSS_COLOR can be set to the BSS color of the first (e.g., sharing) AP that transmits the corresponding NDPA. In this case, for a STA that needs to decode the NDP and that is associated with the first AP, decoding behavior may be unchanged from non-CBF operation. For the first AP (that the STA is associated with), the transmission behavior may similarly be unchanged from non-CBF operation. For the second (e.g., shared) AP that the STA is not associated with, the second AP can set the BSS_COLOR to the BSS color of the first AP, which can differ from non-CBF operation for the second AP.

There can also be multiple possible approaches to handling BSS_COLOR indication in BFR transmissions, according to some embodiments. In CBF, the second (e.g., shared) AP may need to decode a BFR transmitted by a STA associated with the first (e.g., sharing) AP, e.g., if the BFR is part of a CBF sounding sequence in which the second AP is involved, for example to facilitate the second AP forming nulls toward the STA during subsequent CBF data operation. As one possibility, the STA can be configured to set the BSS_COLOR to 0 in the preamble of the BFR. In this case, both the first AP and the second AP can be configured to decode the BFR with such a setting. As another possibility, the BSS_COLOR of the first AP that transmits the corresponding NDPA can be used. In this case, the second AP can configure its filters so that it can decode the BFR. Note that the first AP can potentially decode the BFR without any additional configuration in this case, at least in some embodiments.

Once CBF sounding has been performed, CBF data frame exchange can be performed. Multiple frame exchange sequences are possible for CBF data frame communication, according to various embodiments. FIG. 15 is a timing diagram illustrating example aspects of one such possible frame exchange sequence. As shown, in the illustrated scenario, an announce and response frame exchange can be performed between AP1 (sharing) and AP2 (shared), for example in which CBF configuration and parameters for an upcoming CBF data frame communication can be negotiated. AP1 and STA1 (associated with AP1) can perform an ICF/ICR exchange, after which AP2 and STA2 (associated with AP2) can perform an ICF/ICR exchange. A sync frame may be transmitted by the AP1, then concurrent CBF PPDU transmission can be performed by AP1 and AP2, followed by concurrent BA transmission by STA1 and STA2.

In the illustrated scenario, according to IEEE 802.11be eMLSR rules, STA1 can return to listening operation after receiving an ICF from AP2 in the illustrated frame exchange sequence, which could potentially result in CBF PPDU failure. Accordingly, at least in some embodiments, to mitigate this possibility, AP1 can indicate to STA1 to stay on the link for a longer time (e.g., to not return to listening operation immediately upon detecting an ICF from an OBSS AP). The indication can be a time duration that STA1 is requested to wait on the link before it switches back to listening operation, as one possibility. As another possibility, the indication can be a number of PPDUs that STA1 is requested to decode before it switches back to listening operation. The indication can include an identifier for STA1, such as its AID. The indication can be carried in any or all of an announcement, ICF, ICR, or sync frame, in various embodiments.

Similarly as for during CBF sounding operation, it can be important to protect a TXOP from hidden node transmissions. However, providing NAV protection that accounts for the wireless devices involved in the CBF data frame exchange sequence being part of multiple different BSSs can be challenging. For example, based on baseline NAV rules, ICF/ICR from the sharing AP will prohibit the ICF/ICR/CBF PPDU of the shared AP, in some embodiments. Similarly, ICF/ICR/CBF PPDU of the shared AP will prohibit the CBF PPDU of the sharing AP, in some embodiments. Accordingly, as one possibility, certain exceptions to the NAV rules can be implemented for CBF operation. These exceptions in NAV rules can allow the transmissions of ICF, ICR, Sync, and CBF PPDUs, so that a PPDU sent by one device participating in the CBF does not block PPDU transmission from another participating device in the CBF sequence.

Failure recovery options for the frame exchange sequence of FIG. 15 can also be supported, according to some embodiments. For example, as one possible failure handling case, when ICR from STA1 fails, AP2 can be configured to give up its ICF if it doesn't over hear the ICR from STA1. To support this possibility, AP2 can monitor the ICR from STA1. As another possible failure handling case, when ICF from AP2 fails, AP1 can be configured to perform PIFS recovery to send an in-BSS PPDU if ICF from AP2 is not detected by AP1. As a further possible failure handling case, when ICR from STA2 fails, AP2 can notify AP1 about the failure with PIFS recovery, based on which AP1 can adjust its CBF PPDU (e.g., to proceed without STA2). Another possibility for this failure handling case could include AP1 monitoring ICR from STA2 directly, and if not detected, transmitting a non-CBF PPDU instead of a CBF PPDU. Still another possibility can include proceeding with the original CBF PPDU even with the ICR from STA2 fails.

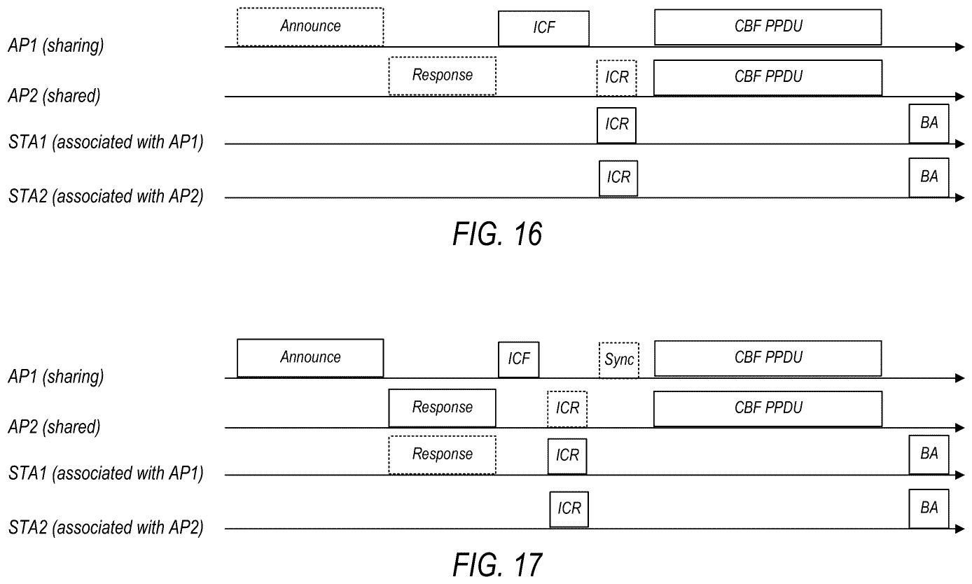

FIG. 16 illustrates example aspects of another possible frame exchange sequence that can be used for CBF data exchange, according to some embodiments. Notably, a multi-user ICF/ICR exchange can be used, in addition to announce/response frames that can be used for CBF scheduling, e.g., for AP2 to indicate intention to participate in CBF, AP1 and AP2 to indicate/select participating STAs (e.g., STA1 and STA2 in the illustrated example), AP1 and AP2 to negotiate parameters for the CBF PPDUs (e.g., preamble settings), and how to schedule BAs. The ICF can include access point identifier information and AID information such as (BSS_COLOR, AID) tuples, to address possible AID collisions between STA1 and STA2. The ICF can have a unique CBF TA (and/or RA) defined in wireless communication standard specifications so that STAs can easily recognize/filter it. The ICF can solicit ICR frames from all participating STAs for NAV protection and to check whether the STAs respond. An ICR frame from the AP2 can be optional, in some embodiments; for example, if AP1 determines to solicit an ICR from AP2 for better NAV protection, AP1 can include a user info field addressed to AP2 in the multi-user ICF. In some embodiments, the ICF can be an extended multi-user request-to-send (MU-RTS) frame and the ICR can be a clear-to-send (CTS) frame. Other ICF/ICR formats can also be possible. In some embodiments, the ICF can allocate AID(s) for STA1 and/or STA2 to sue for decoding the CBF PPDU (e.g., CBF-specific AIDs). Once the multi-user ICF/ICR exchange is complete, concurrent CBF PPDU transmission can be performed by AP1 and AP2, followed by concurrent BA transmission by STA1 and STA2, in the illustrated example.

Failure handling techniques can also be provided for the CBF data exchange approach illustrated in FIG. 16. For example, according to some embodiments, if the response frame is not received from AP2, the AP1 can be configured to give up on the TXOP. If the response frame rejects the sharing, AP1 can be configured to transmit its own data or poll another AP for CBF data exchange participation. If CTS is not received from any STA, AP1 can be configured to give up the CBF PPDU, while if any (but not all) CTS is received from any STA, AP1 can be configured to continue the CBF PPDU. Other techniques are also possible.

FIG. 17 illustrates example aspects of a further possible frame exchange sequence that can be used for CBF data exchange, according to some embodiments. The illustrated exchange sequence can allow AP1 to retain the TXOP even if AP2 fails to respond (e.g., due to a busy medium), and can potentially be implemented with relatively few changes to eMLSR state machine operation and using a sync message, at least in some instances. As shown, the announce frame in the illustrated example exchange sequence can optionally solicit a response from STA1 (and/or other APs that are not shown) simultaneously. The response(s) can be in TB PPDU (e.g., potentially supporting indicating of STA1's ID) or CTS, according to various embodiments. The announce frame can set the NAV to protect the medium until the start of the ICF, as one possibility. The response frame can set the NAV to protect the medium until the start of the ICF, Sync, or CBF PPDU, as various possibilities. The ICR can be sent in a TB PPDU; AP1 may or may not solicit an ICR from AP2; use of TB PPDU can allow AP1 or AP2 to know if STA2 has responded. The Sync message can indicate the ID(s) for AP2, STA1, and/or STA2, which can allow AP1 (or AP2) to know if STA2 has responded. In addition, use of the IDs in the sync message can allow STA1 and STA2 to remain on the link instead of switching back to listening operation (e.g., based on 802.11be eMLSR rules), at least according to some embodiments.

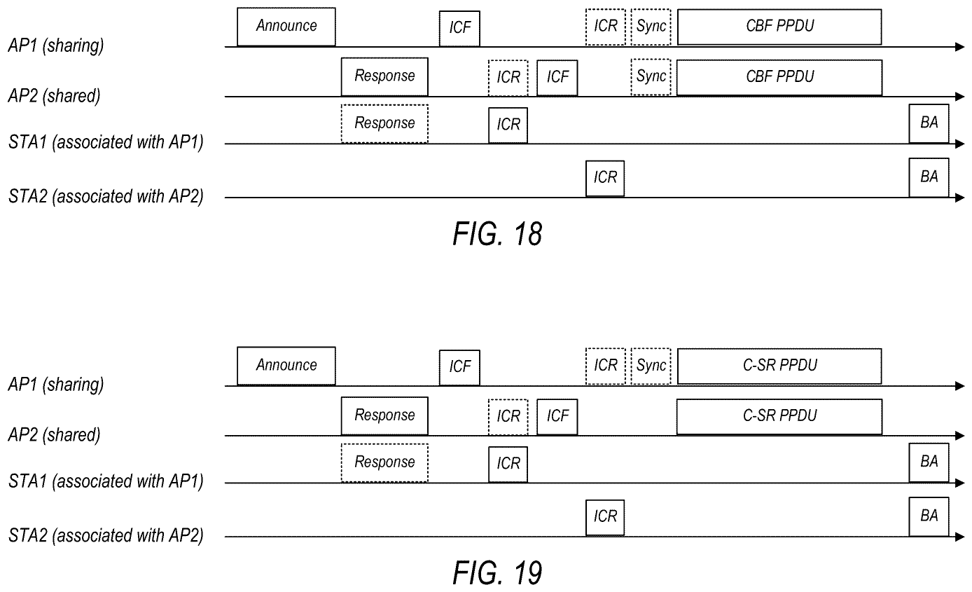

FIG. 18 illustrates example aspects of a still further possible frame exchange sequence that can be used for CBF data exchange, according to some embodiments. As shown, similarly to the scenario of FIG. 17, the announce/response frame exchange can be used to help AP1 find out whether AP2 and/or one or more other (not shown) APs request to join the coordinated beamforming. The response can be in non-HT (dup) PPDU or TB PPDU, according to various embodiments. In some instances, the announce/response frames need not be exchanged as part of the frame exchange sequence, e.g., in case the APs can exchange such information using a wired or other backhaul link. The NAV protection for the ICF from each AP can be set according to AP implementation choice, in some embodiments, for example potentially until the next ICF frame, the Sync frame, the beginning of the CBF PPDU, or the end of the BA transmission, as various possibilities. It can be the case that specification support is provided for at least the ‘long’ NAV (e.g., through the end of the frame exchange sequence) option, e.g., to facilitate more reliable coordinated beamforming operation when hidden nodes are or can be present, at least according to some embodiments. This can apply not only to eMLSR or dynamic power saving (DPS) STAs, but can also apply to non-eMLSR non-DPS STAs, in some embodiments. Either AP1 or AP2 can send a Sync frame SIFS before the CBF PPDU, for example, depending on which AP's clock is used for CFO correction before the CBF PPDU. In this case, AP1 can indicate whether the Sync frame is sent by itself or by AP2 in the Announce frame and/or the ICF frame. If the Announce frame includes a third AP in addition to AP2, the ICF frame from AP1 can also indicate which AP is selected for the CBF PPDU transmission by including the ID of AP2 or that of the third AP.

After the first ICF indicates a time duration for STA1 to wait on the link, it can be specified that AP1 shall not attempt to transmit to STA1 on a different link during the time duration (e.g., even if STA1 is a multi-link operation (MLO) STA), at least in some instances. AP1 can consider the time duration together with the link switch delay for eMLSR or eMLMR operation when calculating the delay for STA1 to switch from the frame exchanges to the listening operation, as one possibility. Similar operations can be applicable to AP2 and STA2: at least in some instances, AP2 can indicate a time duration for STA2 to stay on the link for its PPDU, in which case it can be specified that AP2 shall not attempt to transmit to STA2 on a different link during the time duration. When the ‘long’ NAV option is used, it can be the case that either or both of the first ICF or the second ICF can set a carrier sensing (CS) required subfield to 0, e.g., so that STA1 and/or STA2 can avoid carrier sensing before their responses.

To prevent STA1 and/or STA2 from leaving the primary channel (e.g., for non-primary channel access (NPCA) as can be defined according to one or more IEEE 802.11 specification versions), it can be the case that an explicit indication is introduced in one or more of the ICF, ICR, announce, response, and/or sync frames, e.g., to disallow NPCA based on any of these frames. For example, if any of these frames is a Trigger frame, a reserved field defined in IEEE 802.11be for Trigger frames can be used for such an indication. As another example, if any of these frames is a multi-STA Block Ack frame, a reserved field defined in IEEE 802.11be for Multi-STA Block Ack frames can be used for such an indication.

A similar frame exchange sequence can be used to support coordinated spatial reuse (C-SR) communication, according to some embodiments. In a C-SR scenario, it can be the case that two (or more) APs within communication range can coordinate to each communicate with an associated STA, where the associated STA for each AP is sufficiently far away (or otherwise protected) from the other AP such as to relatively unaffected by interference from the other AP. Thus, C-SR can differ from CBF in that the coordinating APs do not transmit nulling signals, at least according to some embodiments.

FIG. 19 illustrates example aspects of one possible frame exchange sequence that can be used for C-SR data exchange, according to some embodiments. As shown, a (‘sharing’) AP1 and a (‘shared’) AP2 (and possibly one or more potentially participating STAs) can exchange announce/response frames that can be used for C-SR scheduling, e.g., for AP2 to indicate intention to participate in C-SR, AP1 and AP2 to indicate/select participating STAs (e.g., STA1 and STA2 in the illustrated example), AP1 and AP2 to negotiate parameters for the C-SR PPDUs, how to schedule BAs, etc. One or more multi-user ICF/ICR exchanges can be used, e.g., for the AP1 and AP2 to solicit ICR frames from all participating STAs for NAV protection and to check whether the STAs respond. An ICR frame from the AP2 in response to an ICF from AP1, as well as ICR frame from the AP1 in response to an ICF from AP2, can be optional, in some embodiments; for example, if AP1 determines to solicit an ICR from AP2 for better NAV protection, AP1 can include a user info field addressed to AP2 in the multi-user ICF. In some embodiments, the ICF can be an extended multi-user request-to-send (MU-RTS) frame and the ICR can be a clear-to-send (CTS) frame. Other ICF/ICR formats can also be possible. Once the multi-user ICF/ICR exchange is complete, AP1 can transmit a sync frame (e.g., to confirm which APs/STAs are participating in the C-SR data frame, to provide final configuration details for the data frames and/or the corresponding BlockAck frame, etc.) and concurrent C-SR PPDU transmission can be performed by AP1 and AP2, followed by concurrent BA transmission by STA1 and STA2, in the illustrated example.

As noted previously, for C-SR, it can be the case that STA2 is not within range of AP1 and that STA1 is not within range of AP2. Considering this, for AP2 to determine when to transmit its ICF, it can be the case that the AP2 decodes a duration indication in the ICF from AP1 (e.g., using the duration field in the ICF, or a UL Length subfield), and determine the start time of its ICF transmission based on the indication. As another possibility, if solicited by the ICF frame from AP1, AP2 can respond to the ICF with AP2's own ICR based on the solicitation and transmit its ICF a configured amount of time (e.g., SIFS) afterward. A similar approach can be used for the AP1 to determine when to transmit the sync frame. For example, AP1 can decode a duration indication from AP2 (e.g., using the duration field in the ICF, or a UL Length subfield), and determine the start time of the sync frame transmission based on the indication. As another possibility, if solicited by the ICF frame from AP2, AP1 can respond to the ICF with AP1's own ICR based on the solicitation and transmit the sync frame a configured amount of time (e.g., SIFS) afterward. Note that while the C-SR PPDU frames can be transmitted using the same start time (e.g., as illustrated), it can also be possible in some embodiments that a configured offset (e.g., corresponding to a preamble length of the C-SR PPDU, as one possibility) is used between the start times of the C-SR PPDUs.

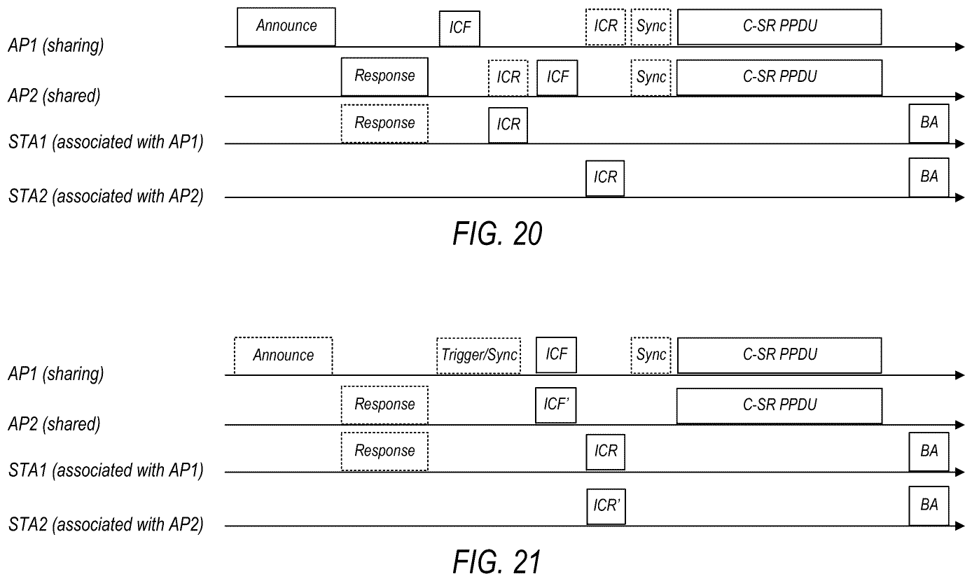

FIG. 20 illustrates further example aspects of a possible C-SR data frame exchange sequence, according to some embodiments. In some embodiments, it can be the case that one of the APs determines to transmit to a STA operating according to a different wireless communication standard version (e.g., a ‘legacy’ version) than the STA to which the other AP determines to transmit. For example, one AP could determine to serve a ‘legacy’ 802.11be STA while the other AP determines to serve a 802.11bn UHR STA, as one possibility. To support such a scenario, it can be the case that whether a legacy STA is served can be indicated in one or more of the announce, response, ICF, ICR, or sync frame. It can be the case that, as shown, either of the APs (e.g., AP1 or AP2) can transmit the sync frame. Note that it can still be the case that only one of the APs transmits the sync frame, and that the AP that transmits the sync frame is implicitly or explicitly determined based on which AP is serving its C-SR PPDU to a legacy STA. For example, the AP that is serving its C-SR PPDU to a legacy STA can also be the AP that transmits the sync frame; this can help keep the legacy STA on the link and avoid it missing the subsequent C-SR PPDU due to returning to eMLSR listening operation, at least according to some embodiments. The sync frame can be a Trigger frame or a CTS-to-self frame, as various possibilities.

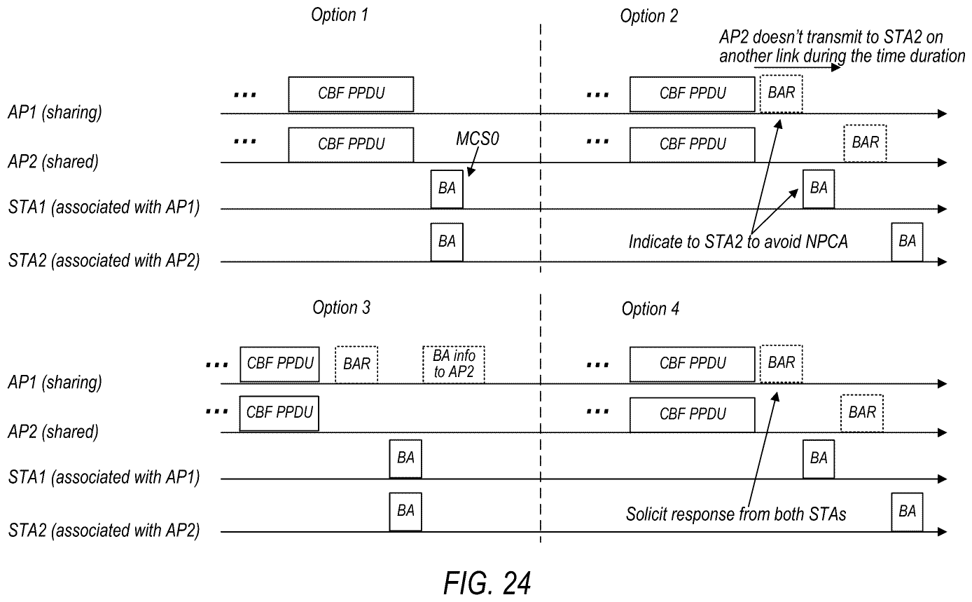

In some embodiments, the C-SR PPDU to the legacy STA from one AP and the C-SR PPDU to the UHR STA from the other AP may be aligned in start time, length and contents for the L-STF, L-LFT and L-SIG in their preambles, so that a device in the vicinity can decode the length of the C-SR transmission reliably. Although in the example scenario of FIG. 19, the BAs are shown as being transmitted concurrently after the C-SR PPDUs, in other embodiments, the BAs can be transmitted in a stagger manner, such as illustrated in Option 2 of FIG. 24. To help the legacy STA transmit its BA in this case, the AP that transmits the C-SR PPDU to the legacy STA can solicit the BA from the legacy STA in the C-SR PPDU or in a BAR frame following the C-SR PPDU so that the BA transmission from the legacy STA occurs before the BA transmission from the UHR STA, at least according to some embodiments.

Note that other C-SR data frame exchange sequence designs are also possible. FIG. 21 illustrates another such possible sequence. As shown, in the illustrated example scenario, AP1 and AP2 can simultaneously transmit ICF and ICF′ frames to solicit ICR and ICR′ frames from STA1 and STA2 respectively. According to one possible design, the ICF and ICF′ frames can have different contents; e.g., ICF can be targeted for STA1 only and ICF′ can be targeted for STA2 only. Since STA1 is not in range of AP2 and STA2 is not in range of AP1, it can potentially be the case that the STAs can decode and respond to the ICF and ICF′ frames without significant interference impact, at least in some embodiments. However, it can also be the case in this scenario that other STAs (e.g., that are within range of both AP1 and AP2) can fail to decode the ICF and/or ICF', and can accordingly interrupt the C-SR sequence, in some instances. To reduce the likelihood of this possibility, a design is also possible in which ICF and ICF′ have the same contents, for example including (BSS_COLOR and AID) tuples to identify both STA1 and STA2, with a special TA and/or RA used to indicate that the frames are for C-SR. Such an approach can potentially provide better NAV protection, albeit potentially at a cost of higher complexity, at least according to some embodiments.

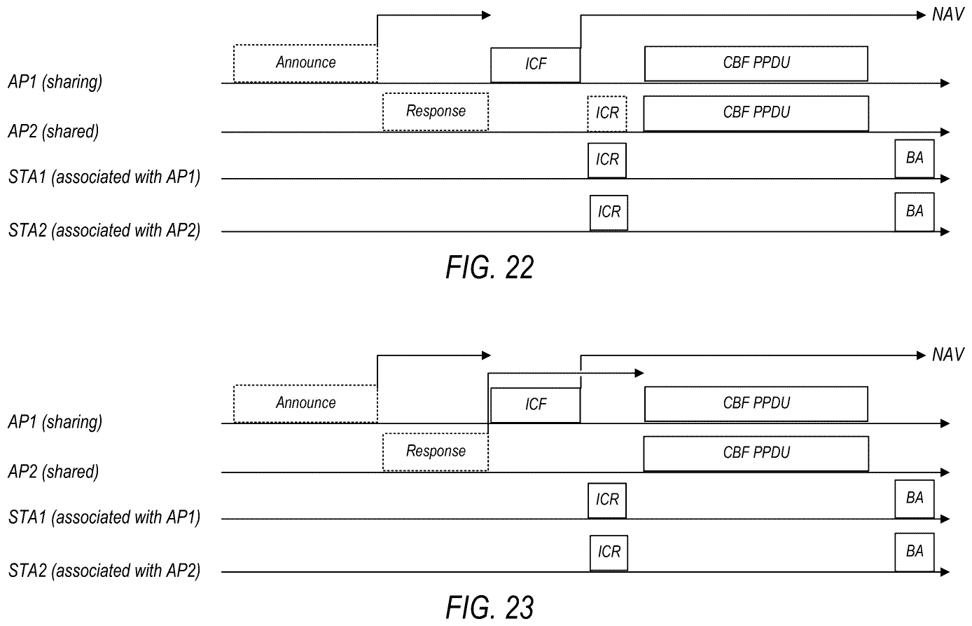

For NAV control for the various possible CBF (and potentially also C-SR) scenarios, as shown in FIG. 22, as one possibility, the announce frame can protect the NAV until the start of the multi-user ICF. As one possibility, the response frame can protect the NAV until the start of the multi-user ICF. The multi-user ICF can protect the NAV until the end of the BA. The remaining frames (e.g., response, ICR, CBF/C-SR PPDU, BA) can inherit the baseline rule to derive the NAV, e.g., including deriving the duration from the preceding frame.

As another possibility, as shown in FIG. 23, the announcement frame can protect the NAV until the start of the ICF, the announcement frame can indicate the start time of the CBF/C-SR PPDU, and the response frame can protect the NAV until the start of the CBF/C-SR PPDU, which can be derived based at least in part on the start time indicated in the announcement frame. In this case, it can be possible that the AP2 does not respond to the multi-user ICF with an ICR. The remaining frames (e.g., response, ICR, CBF/C-SR PPDU, BA) can inherit the baseline rule to derive the NAV, e.g., including deriving the duration from the preceding frame.

Security for a CBF message exchange sequence can also be handled in any of multiple possible ways. As one option, the response frame can carry a fingerprint, STA2 can decode and validate the fingerprint (e.g., a message integrity check (MIC) value, using a low-power radio using the key between AP2 and STA2, as one possibility) and respond to the following multi-user ICF only if the validation is successful. As another possibility, the response frame can carry a similarly constructed fingerprint, and AP2 can rebroadcast the fingerprint in the following multi-user ICF; STA2 can validate the fingerprint received in the multi-user ICF using the key between AP2 and STA2 to determine whether to respond with an ICR. As yet another possibility, a shared key can be defined across the two BSSs. AP1 can add a fingerprint to the multi-user ICF using the shared key. STA1 and STA2 can use the shared key to validate the multi-user ICF and determine whether to respond with an ICR. Other security techniques are also possible.

According to some embodiments, CBF support can be configured such that CBF PPDUs are required to have the same bandwidth. This can help reduce implementation complexity, e.g., including avoiding the need for different tone plans or more complex joint sounding operations in which extra sounding to get beamforming feedback for the extra bandwidth that is covered by only one of the APs, as well as the need for APs to perform nulling on part of the bandwidth and not the other part. Similarly, it can be the case that use of the same puncturing pattern is specified (e.g., according to a wireless communication standard with which the APs and STAs in a communication system comply) as required for concurrent CBF PPDUs, e.g., for similar implementation complexity reduction reasons. Alternatively, as described subsequently herein, it can also be possible that at least some such techniques can be supported, in some embodiments.

There can be multiple options for how to perform BA transmissions for CBF data exchange operation, according to various embodiments. As one option, BAs can be sent in parallel using orthogonal frequency division multiple access (OFDMA) techniques, e.g., as illustrated as “option 1” in FIG. 24. In this case, if one CBF PPDU doesn't solicit a BA, the other BA can be configured to occupy the full bandwidth for SIFS bursting, e.g., to maintain control of the wireless medium. A longer guard interval (GI) (e.g., 3.2 ms, as one possibility) and/or MCS0 can be used, in some embodiments. As another option, staggered BA transmission can be performed, e.g., as illustrated as “option 2” in FIG. 24 (e.g., where the BAR frames can be optional). In this case, eMLSR state machine operation can be modified to support staying on the link instead of going back to listening mode until the BA transmission is complete, for example in case STA2 is an eMLSR STA in the scenario of FIG. 24. The indication for STA1 or STAs to stay on the link instead of going back to listening mode until the BA can be carried in the preceding announce, response, ICF, or CBF PPDU, as various possibilities. The first BAR, if present, and the first BA, can indicate to STA2 to avoid NPCA, in some embodiments. The indication to avoid NPCA can include use of a short NAV or an explicit indication, according to various embodiments. It can also be specified that AP2 shall not transmit to STA2 on a different link during the time duration indicated by the preceding PPDU from AP2, in some instances. In option 3 illustrated in FIG. 24, possibly as an extension of option 1, AP1 can solicit BAs in OFDMA for both APs. Then AP1 can send the BA info for STA2 to AP1, e.g., using over-the-air or backhaul communication. In this case, the BAR frame can also be embedded in the CBF PPDU as an embedded trigger frame, e.g., similar to option 1. In option 4 illustrated in FIG. 24, possibly as an extension of option 2, staggered BA transmission can be triggered by a cross-BSS Trigger (e.g., MU-BAR, as one possibility; other types of BAR are also possible). In this case, the first BAR frame can be required to include the IDs of STA1 and STA2 so that STA2 doesn't go back to eMLSR listening operation, at least according to some embodiments.

In some embodiments, options 1 and 3 can be more efficient in airtime and can potentially require fewer changes to the non-AP STA operation; an embedded trigger frame in each CBF PPDU can be used to solicit the corresponding BA(s) in OFDMA. If a first CBF PPDU needs a responding BA, but a second CBF PPDU doesn't need a responding BA, the solicited BA can be configured to occupy the full bandwidth of the CBF PPDU, e.g., if additional frame exchange is desired SIFS after the BA (e.g., for SIFS bursting after the BA).

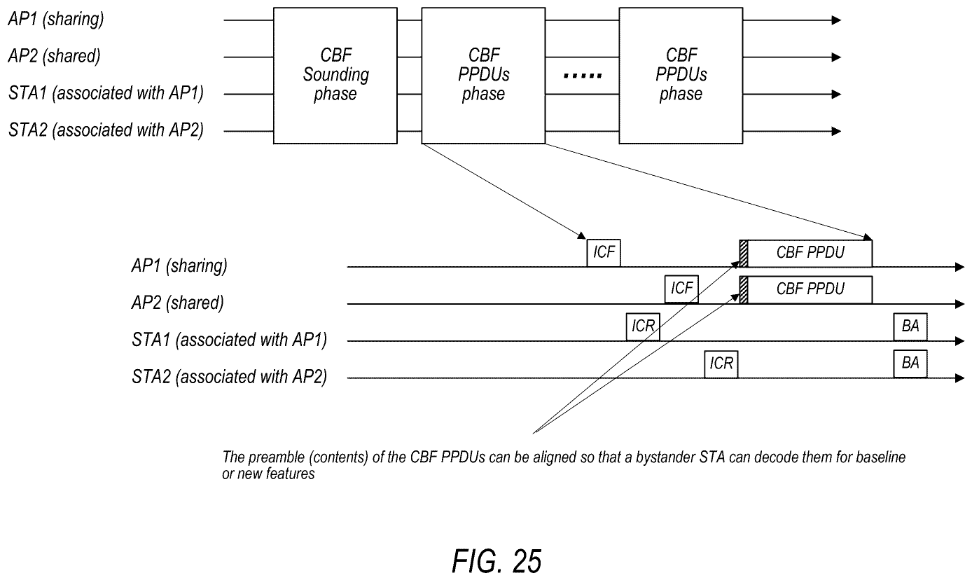

At least in some embodiments, it can be important for at least a portion of the preamble (contents) of the CBF PPDUs (e.g., similar to PPDUs within the CBF sounding phase) to be aligned, e.g., such that a bystander STA can decode them for legacy or new features. Thus, for example, it can be the case that a CBF PPDU transmitted by an AP includes a non-beamformed (omnicast) PHY preamble portion and a portion that is beamformed with spatial nulling. To support such alignment for the omnicast PHY preamble portion, techniques can be provided for unifying the BSS_COLOR and STA_ID settings, in particular to handle scenarios in which the AIDs for a STA1 and STA2 can be the same. FIG. 25 highlights aspects of this potential challenge in CBF data exchange sequence design, according to some embodiments.

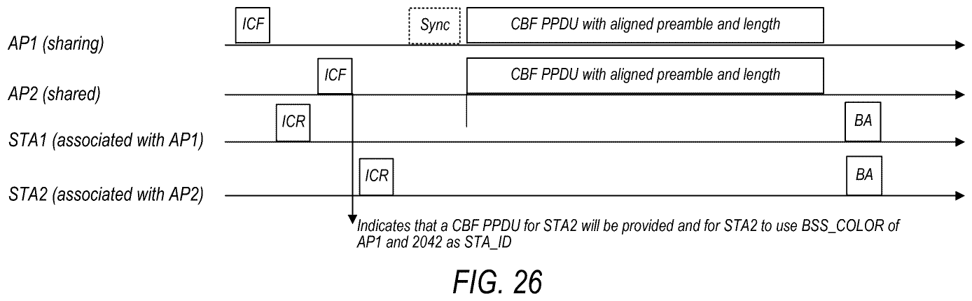

As one possibility, special STA_IDs for STAs of shared AP(s) during CBF can be defined in wireless communication standard specifications. FIG. 26 illustrates example aspects of a possible scenario in which such an approach is used, according to some embodiments. In scenarios in which the maximum number of concurrently served STAs of the shared AP is bounded, (e.g., 3, in the illustrated example; other numbers are also possible), then the specifications can allocate certain special STA_IDs (e.g., 2042-2044, in the illustrated example; other ranges or sets are also possible) for the STAs of the shared AP. In the illustrated example, the second ICF or the Sync frame, or possibly in a multi-user ICF (e.g., such as used in the scenario of FIG. 16, among various other Figures herein), an alternative AID can be assigned for STA2. The same frame can also assign a BSS_COLOR for STA2 to monitor for CBF operation, according to some embodiments.

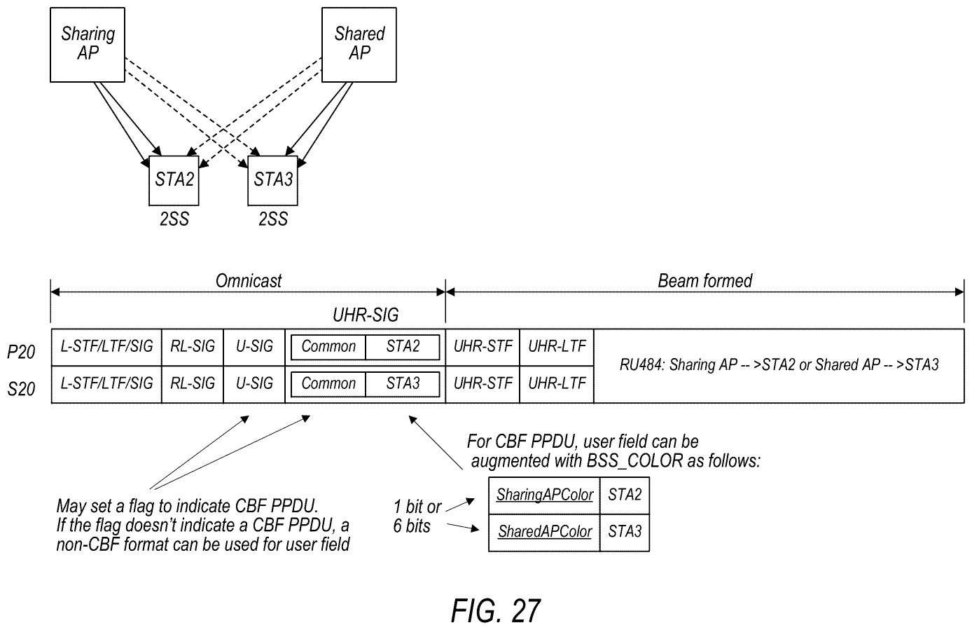

As another possibility, resource unit (RU) allocation in PHY signaling can be expanded based on BSS_COLOR+STA_ID for CBF, while inheriting other existing multi-user multiple input multiple output (MU-MIMO) rules. In various embodiments, BSS_COLOR can be 6 bits (e.g., to indicate a full BSS_COLOR value) or possibly can be 1 bit only (e.g., to indicate either “sharing AP” or “shared AP,” as one possibility). FIG. 27 illustrates example aspects of a possible scenario in which such an approach is used, according to some embodiments. As shown, a flag can be set to indicate a CBF PPDU, and for a CBF PPDU, an augmented user field with BSS_COLOR information can be provided; if the flag doesn't indicate a CBF PPDU, a non-CBF format can be used for the user field.

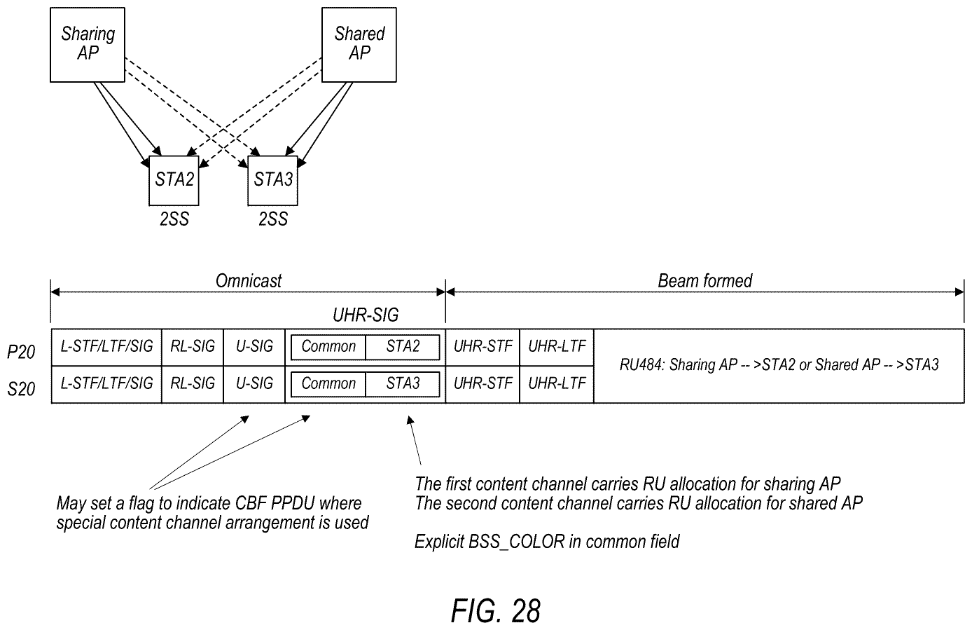

As a further possibility, a first content channel can carry RU allocation for one BSS and a second content channel can carry RU allocation for another BSS. This approach can potentially be more simple to implement and have lower overhead. However, the number of shared APs can be limited by bandwidth in this case; for example, for 20 MHz, CBF can be disallowed if this approach is used; for 40 MHz and above, it can be the case that 1 shared AP can be configured for CBF, at least in some embodiments. FIG. 28 illustrates example aspects of a possible scenario in which such an approach is used, according to some embodiments. As shown, a flag can be set to indicate a CBF PPDU with a special content channel arrangement in use. The first content channel can then carry the RU allocation for the sharing AP and the second content channel can carry the RU allocation for the shared AP. Explicit BSS_COLOR indication can be provided in the common field, at least in some embodiments.

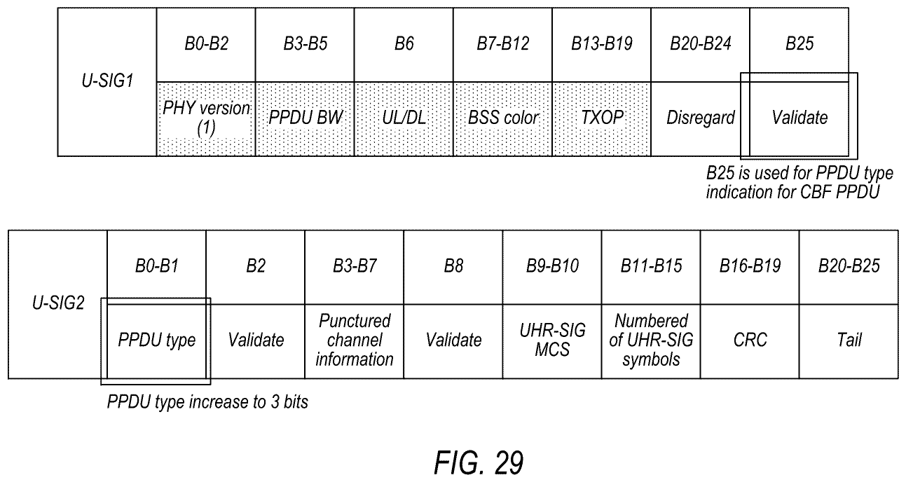

FIG. 29 illustrates further details of a possible PPDU signaling format that can be used for one or more of the approaches of FIGS. 27-28, according to some embodiments. As shown, a CBF PPDU type indication can be provided; for example, 1 bit can be added to PPDU type to signal CBF PPDU (e.g., the PPDU type field can be combined with the neighboring validate bit B25 in U-SIG1). For example, B25 in U_SIG1 could be set to 0 to indicate a CBF PPDU; B0-B1 can combine with B25 of U_SIG1 to indicate coordinated spatial reuse (CSR) or a partial bandwidth CBF PPDU. Another option (not shown in FIG. 29) could include combining the PPDU type field with B2 in U_SIG2 for the PPDU type indication.

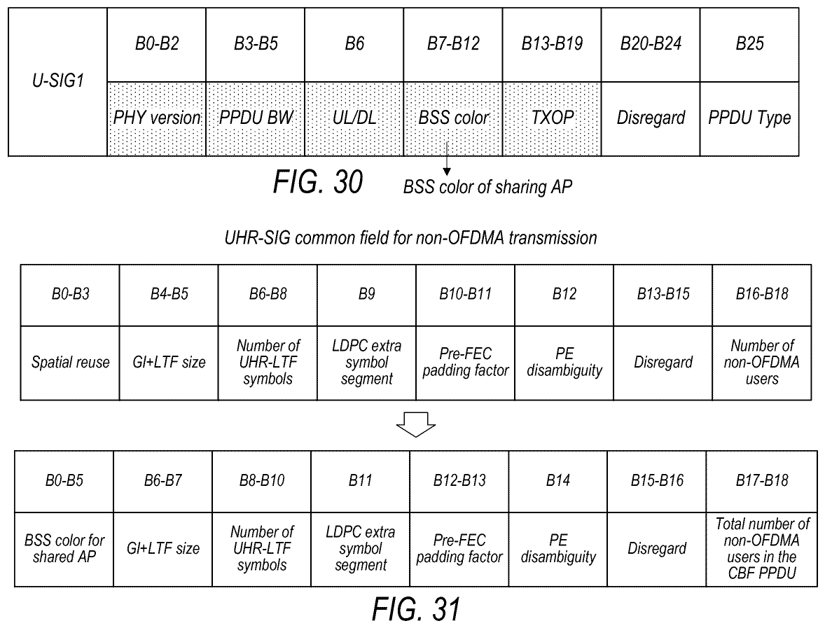

For the sharing AP, the BSS color field can be set to the BSS color of the sharing AP. The BSS color for the shared AP can be signaled in the common field of UHR-SIG, as one possibility. In some embodiments, no spatial reuse allowed on top of CBF PPDU can be assumed, in which case the 4 bits spatial reuse field can be used and combined with 2 disregard bits for BSS color of the shared AP. Some reorganization of fields can also be implemented in this case. The total number of users in the CBF PPDU can also be indicated, possibly with the number of bits used for this indication reduced to 2 bits to accommodate a maximum of 4 users. FIGS. 30-31 illustrate example aspects of such a possible PHY signaling format approach for U-SIG1 and UHR-SIG common fields for non-OFDMA CBF transmission, according to some embodiments.

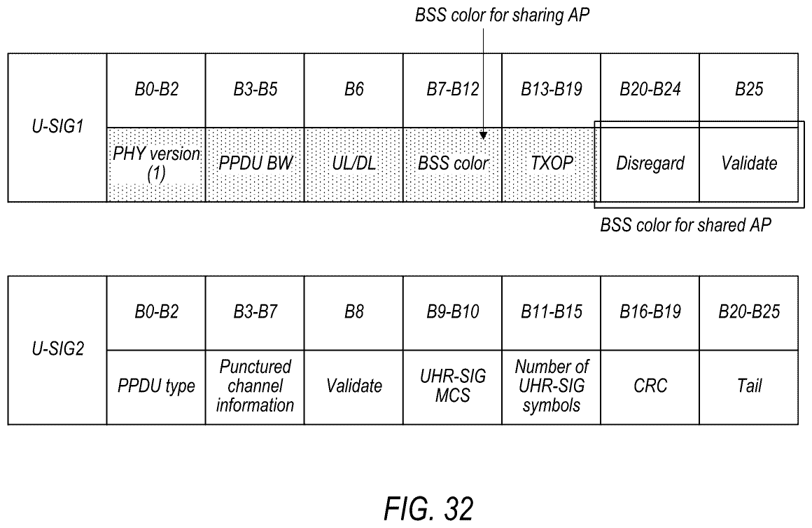

FIG. 32 illustrates aspects of another possible PHY signaling format approach, in which BSS color can be signaled for both APs. As shown, the BSS color field can be set to the BSS color of the sharing AP. 6 bits of the disregard and validate bits in the U-SIG can be indicated to indicate the BSS color for the shared AP, such as B20-B25, according to some embodiments.

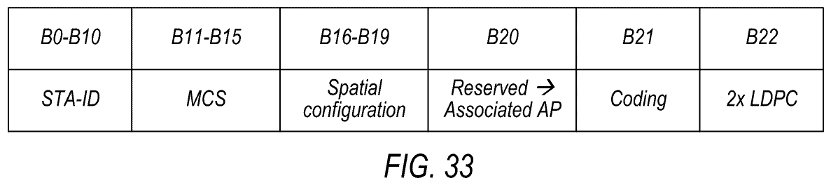

FIG. 33 illustrates aspects of a possible PHY signaling format approach that can be used to differentiate user fields for different APs, for example for use in conjunction with the example approach illustrated in and described with respect to FIG. 27, according to some embodiments. As shown, a 1-bit explicit indication can be provided in the user field to signal a CBF PPDU use user field format for MU-MIMO. A reserved bit (e.g., B20, in the illustrated example) can indicate which AP the signaled STA is associated with; B20 can be set to 0 to indicate that the STA signaled by this user field is associated with the sharing AP, while B20 can be set to 1 to indicate that the STA signaled by this user field is associated with the shared AP, for example.

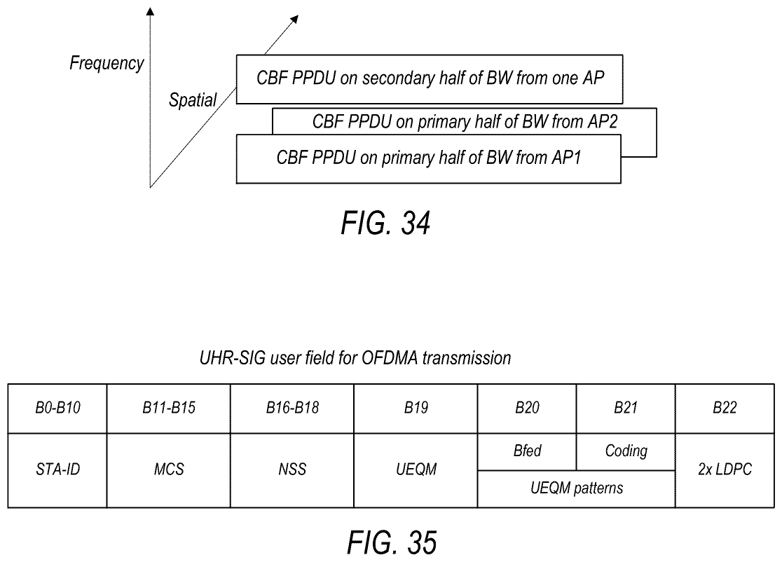

As previously noted herein, in some embodiments, it can be possible that partial bandwidth CBF is supported. FIG. 34 illustrates example aspects of such a possible scenario, in which CBF PPDU transmission is performed on the primary bandwidth channel from both APs and CBF PPDU transmission is performed on the secondary bandwidth channel from one of the APs, according to some embodiments. In some instances, it can be the case that such partial BW CBF is supported only for equal or greater than 160 MHZ PPDU BW. The partial BW CBF can be performed on the primary half of the bandwidth, while the secondary half of the bandwidth is utilized by one AP only and limited to a single RU allocated to a single user. FIG. 35 illustrates a possible UHR-SIG user field for OFDMA transmission for such partial BW CBF operation, according to some embodiments. It can be the case that no preamble puncture is used for the second half of the bandwidth, in some embodiments. For partial bandwidth CBF, it can be the case that the secondary half of bandwidth can only be used by the sharing AP, though in other embodiments this limitation may not be enforced. The sharing AP can be the TXOP initiator and so it can be the case that the shared AP cannot increase the BW for the TXOP. The user field for the CBF PPDU can be a non-OFDMA format. But for the partial BW CBF PPDU, it can be the case that the user field for the STA allocated to the second half of the BW uses OFDMA format. The bandwidth for the U-SIG can be the full BW, at least in some embodiments.

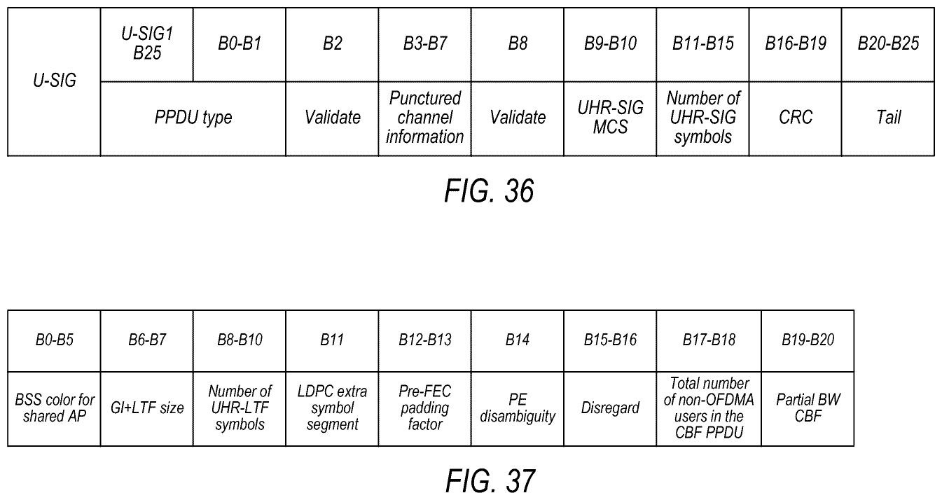

In some embodiments, B0-B2 in U-SIG2 can be used to indicate a partial bandwidth CBF PPDU. For example, in the U-SIG format illustrated in FIG. 36, PPDU Type 000 can be used to indicate a full bandwidth CBF PPDU, and Type 010 can be used to indicate a partial bandwidth CBF PPDU. Other formats can also be used. The UHR-SIG common field for non-OFDMA transmission as illustrated in FIG. 31 can be used, in some embodiments. The UHR-SIG common field for OFDMA transmission can be used if preamble puncture is supported, in some embodiments; it can also be the case that preamble puncture is not supported. The user field for the STA allocated to the second half of the bandwidth of the sharing AP can use the OFDMA format, and can be placed as the last user info field, in some embodiments. Thus, if B17-18 in UHR SIG common field indicates N users, then the first N user fields can use MU-MIMO format and a N+1 user field can use OFDMA format, at least in some instances. For partial bandwidth CBF PPDU, the UHR SIG field can be the same as for full bandwidth CBF PPDU except for an additional user field at the end.

As another option to signal partial bandwidth CBF PPDU transmission, 2 bits in UHR SIG common field can be used to indicate the partial BW CBF PPDU; this can support either the sharing AP or the shared AP to use the secondary bandwidth channel. For example, the UHR SIG common field format illustrated in FIG. 37 can be used, with a B19-B20 value of 00 indicating a full bandwidth CBF PPDU, 01 indicating a partial bandwidth CBF PPDU with the sharing AP using the secondary channel for another user, and the shared AP only using the primary channel for CBF, and 10 indicating a partial bandwidth CBF PPDU with the shared AP using the secondary channel for another user, and the sharing AP only using the primary channel for CBF. If any AP is using the secondary channel for an OFDMA user, the last user field of the corresponding AP can be for the OFDMA user on the secondary channel of the bandwidth and that user field can use OFDMA format, at least in some embodiments.

Note that some or all of the techniques described herein for performing CBF data phase communication can also be applied to other multi-AP communication schemes, such as coordinated spatial reuse (e.g., as described in conjunction with FIGS. 19-21 herein), and joint transmission, in which two APs transmit concurrently, at least according to some embodiments. For example, any or all of the frame exchange sequences, eMLSR state machine configuration techniques, NAV settings, failure recovery, acknowledgement procedures, security, and/or options for CBF PPDU alignment described herein can also or alternatively be used in such scenarios, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A first access point wireless device, comprising:
one or more antennas;
one or more radios operably coupled to the one or more antennas; and
a processor operably coupled to the one or more radios;
wherein the first access point wireless device is configured to:
transmit, to at least a second access point wireless device, an announce frame for a coordinated data frame exchange sequence;
receive, from at least the second access point wireless device, a response frame for the coordinated data frame exchange sequence;
transmit, to at least a first non-access point wireless device that is associated with the first access point wireless device, a first initial control frame (ICF) for the coordinated data frame exchange sequence;
receive, from at least the first non-access point wireless device, an initial control response (ICR) frame in response to the first ICF;
receive, from the second access point wireless device, a second ICF for the coordinated data frame exchange sequence that is addressed to at least a second non-access point wireless device that is associated with the second access point wireless device
transmit a coordinated data frame; and
receive one or more block acknowledgement (BA) frames in response to the coordinated data frame.

2. The first access point wireless device of claim 1,
wherein the coordinated data frame exchange sequence comprises one of:
a coordinated spatial reuse (C-SR) data frame exchange sequence; or
a coordinated beamforming (CBF) data frame exchange sequence,
wherein at least one of the announce frame or the first ICF comprises an indication of whether the coordinated data frame exchange sequence comprises a C-SR data frame exchange sequence or a CBF data frame exchange sequence.

3. The first access point wireless device of claim 1,
wherein the announce frame further solicits a response frame from at least the first non-access point wireless device.

4. The first access point wireless device of claim 1,
wherein the response frame comprises a non-high-throughput duplicate (non-HT dup) physical layer protocol data unit (PPDU).

5. The first access point wireless device of claim 1,
wherein the coordinated data frame comprises a coordinated beamforming (CBF) data frame that includes a non-beamformed physical layer (PHY) preamble portion and a portion that is beamformed to at least the first non-access point wireless device with spatial nulling to at least the second non-access point wireless device.

6. The first access point wireless device of claim 1, wherein the coordinated data frame exchange sequence comprises a coordinated spatial reuse (C-SR) data frame exchange sequence, wherein the first access point wireless device is further configured to:
determine sync frame transmission timing for the C-SR data frame exchange sequence based on at least one of timing of the ICR frame transmitted in response to the second ICF or a duration indication in the second ICF; and
transmit a sync frame for the C-SR data frame exchange sequence using the determined sync frame transmission timing.

7. The first access point wireless device of claim 1, wherein the coordinated data frame exchange sequence comprises a coordinated spatial reuse (C-SR) data frame exchange sequence, wherein the first access point wireless device is further configured to:
provide an indication that the first access point wireless device is serving a legacy non-access point wireless device in the C-SR data frame exchange sequence; and
transmit a sync frame for the C-SR data frame exchange sequence based at least in part on providing the indication that the first access point wireless device is serving a legacy non-access point wireless device in the C-SR data frame exchange sequence.

8. The first access point wireless device of claim 1,
wherein the first ICF includes an indication of a time duration for the first non-access point wireless device to remain on a link.

9. The first access point wireless device of claim 8, wherein the first access point wireless device is further configured to:
determine to not attempt to transmit to the first non-access point wireless device on a different link during the time duration.

10. The first access point wireless device of claim 1,
wherein the first ICF indicates a duration that is configured for use in determining a NAV that provides protection until an end of the one or more BA frames,
wherein a carrier sensing required subfield of the ICF is set to 0.

11. The first access point wireless device of claim 1, wherein the one or more BA frames are received concurrently in time using orthogonal frequency division multiple access (OFDMA), wherein the first access point wireless device is further configured to:
provide BA information for the second non-access point wireless device to the second access point wireless device via a backhaul link.

12. The first access point wireless device of claim 1,
wherein the first ICF indicates that the second access point wireless device is selected for the coordinated data frame transmission.

13. A method for operation in wireless communication, comprising:
receiving, from a first access point wireless device, by a second access point wireless device, an announce frame for a coordinated data frame exchange sequence, wherein the announce frame is addressed to at least the second access point wireless device;
transmitting, to the first access point wireless device, a response frame for the coordinated data frame exchange sequence;
receiving a first initial control frame (ICF) for the coordinated data frame exchange sequence, wherein the first ICF is addressed to at least a first non-access point wireless device that is associated with the first access point wireless device;
transmitting, to at least a second non-access point wireless device that is associated with the second access point wireless device, a second ICF for the coordinated data frame exchange sequence;
receiving, from at least the second non-access point wireless device, an initial control response (ICR) frame in response to the second ICF;
transmitting a coordinated data frame; and
receiving one or more block acknowledgement (BA) frames in response to the coordinated data frame.

14. The method of claim 13,
wherein the coordinated data frame exchange sequence comprises one of:
a coordinated spatial reuse (C-SR) data frame exchange sequence; or
a coordinated beamforming (CBF) data frame exchange sequence, wherein at least one of the announce frame or the first ICF comprises an indication of whether the coordinated data frame exchange sequence comprises a C-SR data frame exchange sequence or a CBF data frame exchange sequence.

15. The method of claim 13, wherein the method further comprises:
determining second ICF transmission timing for the coordinated data frame exchange sequence based at least in part on timing of the ICR frame transmitted in response to the first ICF.

16. The method of claim 13, wherein the method further comprises:
determining second ICF transmission timing for the coordinated data frame exchange sequence based at least in part on a duration indication in the first ICF.

17. The method of claim 13, wherein the method further comprises:
providing an indication that the second access point wireless device is serving a legacy non-access point wireless device in the coordinated data frame exchange sequence; and
transmitting a sync frame for the coordinated data frame exchange sequence based at least in part on providing the indication that the second access point wireless device is serving a legacy non-access point wireless device in the coordinated data frame exchange sequence.

18. An apparatus, comprising a processor and memory configured to cause the processor to:
receive, from a first access point wireless device, an initial control frame (ICF) for a coordinated data frame exchange sequence;
generate, in response to the ICF, an initial control response (ICR) frame configured for transmission to the first access point wireless device;
receive a coordinated data frame; and
generate, in response to the coordinated data frame, a block acknowledgement (BA) frame that is configured for transmission to the first access point wireless device.

19. The apparatus of claim 18, wherein the coordinated data frame exchange sequence comprises one of:
a coordinated spatial reuse (C-SR) data frame exchange sequence; or
a coordinated beamforming (CBF) data frame exchange sequence, wherein at least one of an announce frame or the ICF comprises an indication of whether the coordinated data frame exchange sequence comprises a C-SR data frame exchange sequence or a CBF data frame exchange sequence.

20. The apparatus of claim 18, wherein the memory is further configured to cause the processor to:
receive, from the first access point wireless device, an announce frame for the coordinated data frame exchange sequence;
generate a response frame for the coordinated data frame exchange sequence that is configured for transmission to the first access point wireless device.
